(19) United States
(12) Patent Application Publication
(10) Pub. No.: US 2022/0236566 A1
(43) Pub. Date: Jul. 28, 2022

(54) WEARABLE DEVICE

(71) Applicant: SAMSUNG ELECTRO-MECHANICS CO., LTD., Suwon-si (KR)

(72) Inventors: Do Hwan KIM, Suwon-si (KR); Dong Hoon LEE, Suwon-si (KR); Sang Hyun JI, Suwon-si (KR); Jung Hyun PARK, Suwon-si (KR); Jae Youn PARK, Suwon-si (KR); Byung Gi AN, Suwon-si (KR)

(73) Assignee: SAMSUNG ELECTRO-MECHANICS CO., LTD., Suwon-si (KR)

(21) Appl. No.: 17/560,954

(22) Filed: Dec. 23, 2021

(30) Foreign Application Priority Data
Jan. 28, 2021 (KR) 10-2021-0012365

(51) Int. Cl. G02B 27/01; G02C 5/02; G02C 11/00

(52) U.S. Cl. CPC G02B 27/0172; G02C 5/02; G02B 2027/0138; G02B 2027/0178; G02C 11/10

(57) ABSTRACT

A wearable device includes: a lens; a frame including a rim surrounding the lens and a temple extending from the rim; a reflection member altering a path of light incident from a side in front of the lens toward the lens; an image sensor collecting light reflected from the reflection member; and at least one camera lens disposed on a path of the light collected by the image sensor.

### CROSS-REFERENCE TO RELATED APPLICATIONS

This application claims benefit under 35 U.S.C. § 119(a) of Korean Patent Application No. 10-2021-0012365 filed on Jan. 28, 2021 in the Korean Intellectual Property Office, the entire disclosure of which is incorporated herein by reference for all purposes.

### BACKGROUND

### 1. Field

The following description relates to a wearable device and, for example, a technology related to a secondary battery and a camera employed in a wearable device.

### 2. Description of Related Art

With the development of integrated circuit technology as well as display and battery technology, it has become possible to wear electronic devices as accessories in ways beyond simply carrying them. For example, smartwatches, smartglasses, and other items that have traditionally been in the realm of fashion or accessories have been manufactured to include processors, displays, and various sensors.

However, it is very important that a wearer not feel discomfort in daily life even if the wearer basically always wears the wearable device like clothes. For example, smartwatches are becoming more aesthetically pleasing and lightweight, like traditional wristwatches. If a wearable device is heavy or unpleasing in appearance, and the wearer is thus reluctant to use it, no matter how various and convenient functions the wearable device provides, the practical utility of the wearable device is inevitably low.

Since wearable devices may have a small size as compared with a smartphone, it may be difficult to insert a general battery in wearable devices. A battery using a liquid electrolyte has a high risk of electrolyte leakage, fire, and explosion. In particular, since wearable devices are often used in close contact with a user's body, safety devices are essential when using a liquid electrolyte battery, which has a negative effect on miniaturization of the battery.

In addition, due to the spatial limitations of the wearable devices, a space for mounting a camera in a wearable device may be insufficient, and even if a camera is mounted in the wearable device, the appearance of the wearable device may be negatively affected.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a wearable device includes: a lens; a frame including a rim surrounding the lens and a temple extending from the rim; a reflection member altering a path of light incident from a side in front of the lens toward the lens; an image sensor collecting light reflected from the reflection member; and at least one camera lens disposed on a path of the light collected by the image sensor.

The reflection member may be at least partially disposed inside the rim, and the image sensor may be embedded in the frame.

The wearable device may further include at least one electronic component electrically connected to the image sensor and embedded in the temple.

The temple may be foldably coupled to the rim, the image sensor may be electrically connected to the at least one electronic component, and the at least one electronic component may be embedded in the temple through a flexible board.

The reflection member may be a part of the lens.

The lens may include a reflection surface configured to alter a path of light toward the image sensor.

The glass lens may further include a recess at least partially defined by the reflection surface.

The reflection member and the image sensor may be embedded in the rim.

The rim may include two rims, and the frame may further include a bridge connecting of the two rims. Any one or any combination of any two or more of the reflection member, the lens, and the image sensor may be embedded in the bridge.

The wearable device may further include a light guide prism. The light guide prism may be configured to reflect light incident to the light guide prism at least twice inside the light guide prism.

The wearable device may further include a wide-angle lens disposed on an object side of the reflection member.

The wearable device may further include: electronic components; and solid-state batteries configured to supply power to the electronic components.

Each of the solid-state batteries may include: a cathode; an anode; a body including a solid electrolyte layer disposed between the cathode and the anode; and a first external electrode and a second external electrode, the first external electrode being disposed on one surface of the body and connected to the cathode, and the second external electrode being disposed on another surface of the body opposite to the one surface of the body and connected to the anode.

The wearable device may further include battery cells each including at least one of the solid-state batteries. The battery cells may be configured to supply power to the electronic components, respectively.

The wearable device may further include a power manager electrically connected to the battery cells. The power manager may be configured to selectively discharge a battery cell among the battery cells that is allocated to an activated electronic component among the electronic components.

The wearable device may further include a power manager electrically connected to the battery cells. The power manager may be configured to preferentially charge a battery cell, among the battery cells, that has a low state of charge over a battery cell, among the battery cells, that has a high state of charge.

The wearable device may further include: a power manager electrically connected to the solid-state batteries; a main processor; and a lithium ion battery. The power manager may be configured to determine whether to discharge the lithium ion battery based on whether the main processor is activated.

In another general aspect, a wearable device includes: a lens; a frame surrounding the lens; a temple extending from the frame; electronic components; battery cells configured to supply power to the electronic components, respectively, each of the battery cells including at least one solid-state battery; and a power manager configured to selectively discharge a battery cell among the battery cells that is allocated to an activated electronic component among the electronic components.

The electronic components, the battery cells, and the power manager may be disposed in the temple.

The wearable device may further include a camera disposed in the frame. A battery cell, among the battery cells, may be configured to supply power to the camera.

The wearable device may further include a main battery. The power manager may be further configured to selectively discharge the main battery to charge a battery cell among the battery cells.

The power manager may be further configured to preferentially charge a battery cell, among the battery cells, that has a low state of charge over a battery cell, among the battery cells, that has a high state of charge.

The wearable device may further include: a main processor; and a main battery. The power manager may be further configured to determine whether to discharge the main battery based on whether the main processor is activated.

Other features and aspects will be apparent from the following detailed description, the drawings, and the claims.

### BRIEF DESCRIPTION OF DRAWINGS

FIG. 1 illustrates a wearable device, according to an embodiment.

FIG. 2 is a block diagram illustrating components included in the wearable device, according to an embodiment.

FIG. 3 illustrates a board disposed in a temple and electronic components mounted on the board, according to an embodiment.

FIG. 4 illustrates connection between a plurality of solid-state batteries and the electronic component, according to an embodiment.

FIG. 5 illustrates the solid-state battery, according to an embodiment.

FIG. 6 is a cross-sectional view taken along line I-I′ of FIG. 5.

FIG. 7 is a block diagram illustrating power management using the solid-state battery, according to an embodiment.

FIG. 8 is a flowchart illustrating a discharge of the solid-state battery corresponding to a used device, according to an embodiment.

FIG. 9 is a flowchart illustrating a charge of the solid-state battery based on a state of charge, according to an embodiment.

FIG. 10 is a flowchart illustrating selective use of a main battery based on an operation state of a processor, according to an embodiment.

FIG. 11 illustrates a circuit supplying power to the processor, according to an embodiment.

FIG. 12 is a flowchart illustrating a power supply method in which the main battery is used to assist the solid-state battery, according to an embodiment.

FIG. 13 illustrates first and second cameras mounted on the wearable device, according to an embodiment.

FIG. 14 illustrates a hinge connecting a rim and a temple of the wearable device, according to an embodiment.

FIG. 15A illustrates a state in which a portion of a glass lens functions as a reflection member, according to an embodiment.

FIG. 15B illustrates a state in which a portion of the glass lens functions as the reflection member, according to an embodiment.

FIG. 16A is a cross-sectional view taken along line II-II′ of FIG. 15A.

FIG. 16B is a cross-sectional view taken along line III-III′ of FIG. 15B.

FIG. 17 illustrates a state in which the first camera is disposed in an upper portion of the rim, according to an embodiment.

FIG. 18 illustrates a state in which the first camera is disposed at a bridge of the wearable device, according to an embodiment.

FIG. 19 illustrates a state in which two cameras are disposed on the bridge of the wearable device, according to an embodiment.

FIGS. 20A through 20D illustrate various forms of a light guide prism, according to an embodiment.

FIG. 21 illustrates a lens additionally provided on the reflection member of the first camera, according to an embodiment.

FIG. 22 illustrates a state in which a subject positioned behind a wearer of the wearable device is displayed, according to an embodiment.

FIG. 23 illustrates gesture recognition using the wearable device, according to an embodiment.

FIG. 24 illustrates a state in which users located in different places share fields of view with each other, according to an embodiment.

FIG. 25 illustrates a keyboard input using a gaze of the wearer, according to an embodiment.

FIG. 26 illustrates a driver wearing the wearable device and a field of view of the driver, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

Herein, it is to be noted that use of the term “may” with respect to an embodiment or example, e.g., as to what an embodiment or example may include or implement, means that at least one embodiment or example exists in which such a feature is included or implemented while all examples and examples are not limited thereto.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

An electronic device according to various embodiments herein may include at least one of, for example, a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device. According to various embodiments, the wearable device may include at least one of an accessory-type device (for example, a watch, a ring, a bracelet, an anklet, a necklace, glasses, contact lenses, or a head-mounted device (HMD)), a fabric- or clothes-integrated device (for example, electronic clothes), a body attached-type device (for example, a skin pad or tattoo), or an implantable device (for example, an implantable circuit).

Hereinafter, the electronic device according to an embodiment in the present disclosure will be described in detail with reference to the accompanying drawings.

### Overall Configuration of Wearable Device

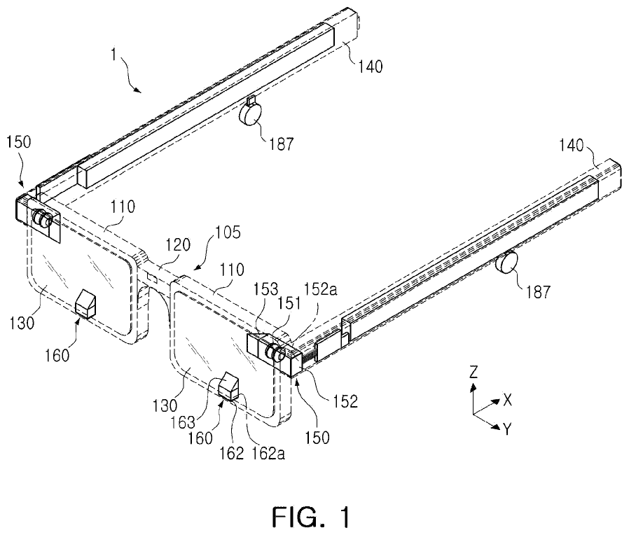

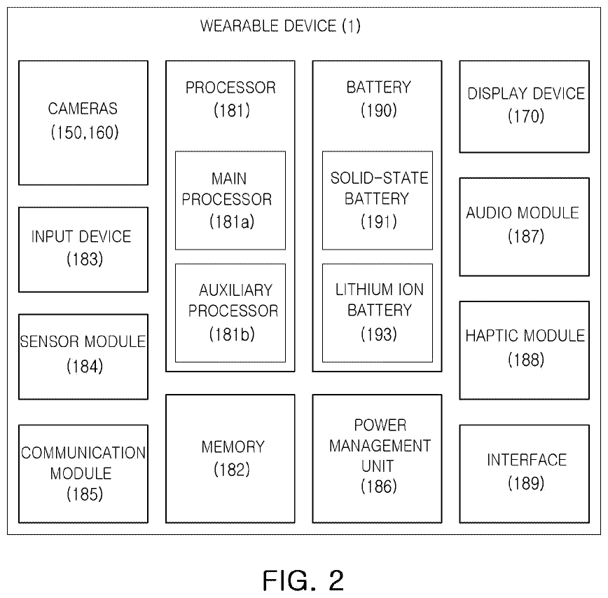

FIG. 1 illustrates a wearable device 1, according to an embodiment. FIG. 2 is a block diagram illustrating components included in the wearable device 1, according to an embodiment.

The wearable device 1 may have a form of smartglasses, but is not limited thereto. Some or all of the components described herein may be applied to a wearable device having a different form according to another embodiment as well.

The wearable device 1 may have a form that a user can wear, such as glasses. The wearable device 1 may include a glass lens 130 disposed in front of the eyes of the user and a frame 105 to which the glass lens 130 is coupled. In this disclosure, the glass lens 130 may be referred to as a glass lens in order to distinguish the glass lens 130 from a first lens 151 and a second lens of first and second cameras 150 and 160, respectively. However, the glass lens 130 is not limited to being made of a glass material and may be made of a polymer material, for example. The frame 105 of the wearable device 1 may include two rims 110 accommodating the glass lens 130 and a bridge 120 connecting the two rims 110. The wearable device 1 may further include a temple 140 extending from the rim 110 and configured to be hung or otherwise supported on the ear of the wearer.

Herein, unless described otherwise, a side in front of the wearable device 1 or the glass lens 130 means a direction (that is, −X direction) in which a field of view of the wearer is directed when the wearer wears the wearable device 1, and a side behind the wearable device 1 or the glass lens 130 means a direction (that is, +X direction) opposite to the direction in which the field of view of the wearer is directed when the wearer wears the wearable device 1. Further, a lateral side of the wearable device 1 means the left side or the right side (that is, +Y or −Y direction).

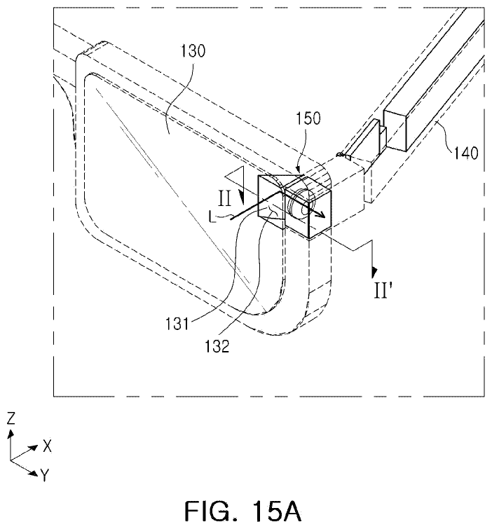

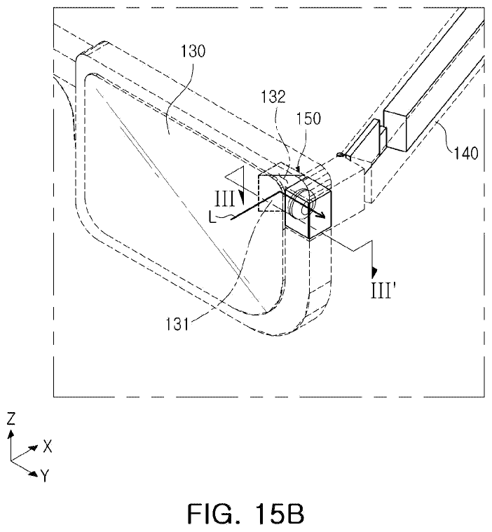

According to an embodiment, the wearable device 1 may include at least one lens, an image sensor, and a reflection member configured to change a path of incident light toward the image sensor. The reflection member may be a part of the glass lens 130 or may be a member such as a prism or a mirror independent of the glass lens 130. According to an embodiment, the image sensor may be disposed inside the frame 105. For example, the image sensor may be embedded in the rim 110 surrounding the glass lens 130. According to an embodiment, the image sensor may be oriented in a direction orthogonal or substantially orthogonal to a direction in which the glass lens 130 is oriented. For example, referring to FIG. 1, the glass lens 130 may have a light transmission surface facing the X direction, and a first image sensor 152 may have an image sensing plane facing the −Y direction. A second image sensor 162 may have an image sensing plane facing a +Z direction. A first reflection member 153 may be configured to make a path of light incident toward the eye of the user from the glass lens 130 (that is, in the +X direction) be directed in the Y direction. A second reflection member 163 may be configured to make a path of light incident toward the glass lens 130 from the eye of the user (that is, in the '1X direction) be directed in the Z direction. According to an embodiment, a plurality of lenses may be arranged between the first or second reflection member 153 or 163 and the first or second image sensor 152 or 162, respectively. The plurality of lenses may be arranged in a direction orthogonal or substantially orthogonal to the direction in which the glass lens 130 is oriented. According to an embodiment, the wearable device 1 may include one or more cameras, for example, a first camera 150 and a second camera 160. According to an embodiment, the first camera 150 may include at least one first lens 151 configured to refract light, and the image sensor 152. The first camera 150 may further include the first reflection member 153. According to an embodiment, the second camera 160 may include at least one second lens configured to refract light, and the image sensor 162. The second camera 160 may further include the second reflection member 163. According to an embodiment, the first and second image sensors 152 and 162 may include any one or any combination of any two or more of a color image sensor, a monochrome image sensor, an ultraviolet sensor, an infrared sensor, and a thermal imaging sensor. According to an embodiment, the first and second cameras 150 and 160 may be configured to collect light incident through a part of a region surrounded by the rim 110. The first or second reflection member 153 or 163 may be at least partially disposed in the rim 110 and may be visually recognized when the wearable device 1 is viewed from the side in front of the wearable device 1. For example, a reflection surface of the first or second reflection member 153 or 163 may be disposed in the region surrounded by the rim 110. That is, a part of light passing through the inside of the rim 110 may enter into the first camera 150 or the second camera 160 through the first reflection member 153 or the second reflection member 163. According to an embodiment, the reflection surface (for example, a reflection surface 141 of FIG. 15A) configured to change a path of light is at least partially positioned inside the rim 110 when the wearable device 1 is viewed from the side in front of the wearable device 1 (that is, when viewed in the X direction). For example, referring to FIG. 1, the first or second reflection member 153 or 163 may be at least partially positioned inside the rim 110 when the wearable device 1 is viewed from the side in front of the wearable device 1 (that is, when viewed in the X direction). According to an embodiment, the first or second camera 150 or 160 may be at least partially accommodated in the frame 105. According to an embodiment, any one or any combination of any two or more of the at least one lens first lens 151, the at least one second lens, the image first image sensor 152, the second image sensor 162, the first reflection member 153, and the second reflection member 163 may be accommodated in the rim 110.

According to an embodiment, the first or second camera 150 or 160 may provide an image stabilization function or an automatic focusing function by moving, instead of the first lens 151 or the second lens, the first or second image sensor 152 or 162 in a direction orthogonal to an optical axis or an optical axis direction. An actuator configured to move the first or second image sensor 152 or 162 may include, for example, a voice coil motor, a shape memory alloy wire, a piezoelectric element, or the like.

According to an embodiment, the wearable device 1 may include the first camera 150 and the second camera 160 disposed adjacent to the rim 110. The first camera 150 may move along the head of the wearer and capture an image of a subject positioned in front of the wearer. In this disclosure, the first camera 150 may be referred to as a head tracking camera. According to an embodiment, the second camera 160 may capture an image of the eye of the wearer and the wearable device 1 may determine a direction or a point to which the gaze of the wearer is directed by using the second camera 160. In this disclosure, the second camera 160 may be referred to as an eye tracking camera.

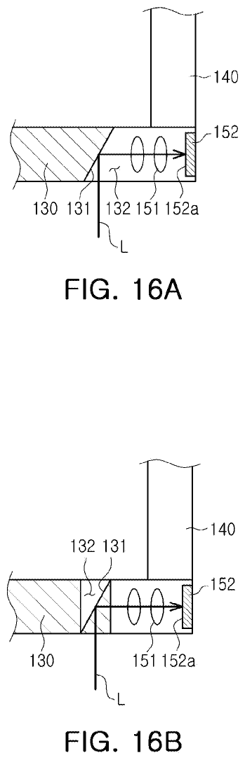

According to an embodiment, the first or second camera 150 or 160 may include the first or second reflection member 153 or 163. The first or second reflection member 153 or 163 may be configured to change a direction of light, and may be implemented by, for example, a prism or a mirror. As another example, the glass lens 130 may be partially machined to provide the reflection surface, and in this case, a portion of the glass lens 130 may provide a function similar to that of the first or second reflection member 153 or 163. A more detailed description of the reflection surface of the glass lens 130 will be provided with reference to FIGS. 15A to 16B.

Since the first or second camera 150 or 160 includes the first or second reflection member 153 or 163, the first or second image sensor 152 or 162 need not be oriented in a direction in which image capturing is to be performed. That is, the first or second image sensor 152 or 162 may be oriented in various directions, and thus, the wearable device 1 may secure a sufficient degree of freedom in installing the camera. As a result, a camera having an excellent performance may be provided without impairing an appearance of the wearable device 1.

According to an embodiment, the first reflection member 153 of the first camera 150 may reflect, toward the first image sensor 152, light incident toward the wearer from the side in front of the wearable device 1. As a result, an imaging surface 152a of the first image sensor 152 of the first camera 150 is not required to be oriented toward the side in front of the wearable device 1, and may be oriented in various directions according to design convenience. For example, in a case in which the first reflection member 153 changes a direction of light incident from the side in front of the wearable device 1 by 90 degrees, the first image sensor 152 may be oriented toward the lateral side of the wearable device 1. Unless otherwise described herein, a direction in which the first image sensor 152 is oriented means a direction that the imaging surface 152a of the first image sensor 152 faces.

According to an embodiment, the second reflection member 163 of the second camera 160 may change, toward the second image sensor 162, a direction of light reflected from the eye of the wearer. For example, the second image sensor 162 may be disposed so that an imaging surface 162a is oriented upwardly (that is, in the +Z direction). As a result, the imaging surface 162a of the second image sensor 162 of the second camera 160 is not required to be oriented toward the eye of the wearer, and may be oriented in various directions according to design convenience. For example, in a case in which the second reflection member 163 changes a direction of light incident from behind the rim 110 by 90 degrees, the second image sensor 162 may be oriented toward an upper side of the wearable device 1.

According to an embodiment, one first camera 150 and one second camera 160 are provided at the rims 110, respectively. However, this is only an example. According to another embodiment, only one first camera 150 or one second camera 160 may be provided at the left side or the right side. For example, the first camera 150 and the second camera 160 may be provided on the left side of the wearable device 1, and the camera does not have to be disposed on the right side.

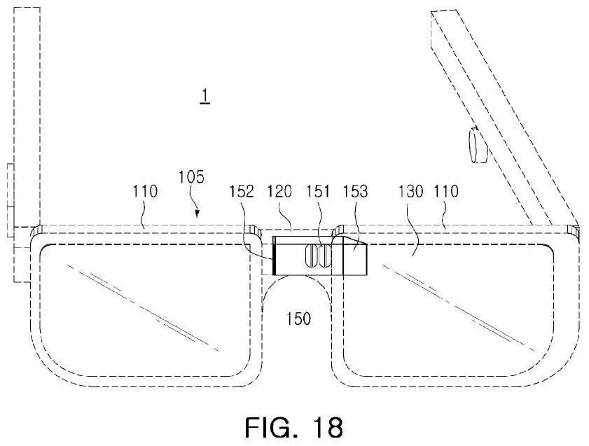

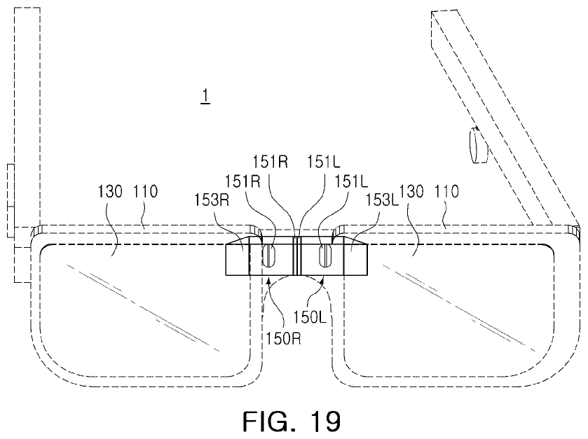

The positions at which the first camera 150 and the second camera 160 are disposed are not limited to those illustrated in the drawings. For example, the first camera 150 may be disposed at the bridge 120 of the wearable device 1, as illustrated in FIG. 18 or 19. As another example, the first camera 150 may be disposed at a lower side of the rim 110, rather than being disposed at the upper side of the rim 110.

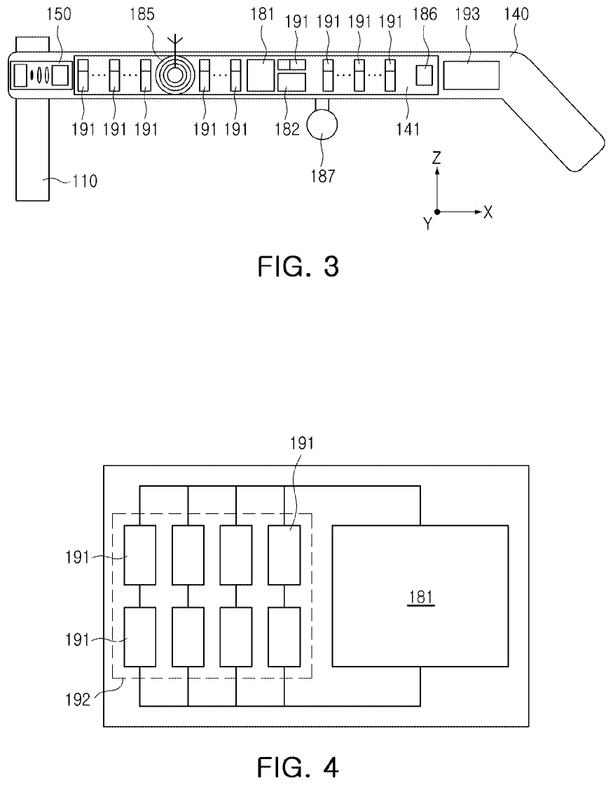

Referring to FIGS. 2 and 3, according to an embodiment, the wearable device 1 may include various electronic components (for example, a processor 181, a memory 182, and a battery 190 including a solid-state battery 191 and a lithium ion battery 193, for example). At least some of the electronic components may be accommodated in the temple 140 of the wearable device 1. For example, at least some of the electronic components may be embedded in the temple 140. A board 141 may be accommodated in the temple 140 of the wearable device 1, and the electronic components may be mounted on the board 141. According to an embodiment, the first or second image sensor 152 or 162 may be electrically connected to at least one electronic component accommodated in the temple 140.

For example, the processor 181 may control at least one different component (for example, a hardware component or software component) of the wearable device 1 that is connected to the processor 181 by executing software (for example, a program), and may perform various data processes or operations. According to an embodiment, as at least a part of the data processing or operation, the processor 181 may load a command or data received from another component (for example, a sensor module 184 (which may also be referred to as a sensor device 184) or a communication module 185 (which may also be referred to as a communicator 185)) on the memory 182, may process a command or data stored in the memory 182, or may store result data in the memory 182. According to an embodiment, as shown in FIG. 2, the processor 181 may include a main processor 181a (for example, a central processing unit (CPU) or an application processor), and an auxiliary processor 181b (for example, a graphics processing unit (GPU), an image signal processor, a sensor hub processor, or a communication processor) that may be operated independently of or in cooperation with the main processor 181a. Additionally or alternatively, the auxiliary processor 181b may be set to use low power as compared with the main processor 181a or to be specialized for a specific function. The auxiliary processor 181b may be implemented independently of the main processor 181a or may be implemented as a part of the main processor 181a.

The auxiliary processor 181b may control at least some of functions or states related to at least one (for example, a display device 170, the sensor module 184, or the communication module 185) of the components of the wearable device 1, instead of the main processor 181a while the main processor 181a is in an inactive state (for example, a sleep state), or in cooperation with the main processor 181a while the main processor 181a is in an active state (for example, an application execution state). According to an embodiment, the auxiliary processor 181b (for example, an image signal processor 181 or a communication processor 181) may be implemented as a part of another functionally related component (for example, the first or second camera module 150 or 160 or the communication module 185).

The memory 182 may store various data used by at least one component (for example, the processor 181 or the sensor module 184) of the wearable device 1. Examples of the data may include software (for example, a program) and input data or output data for a command related thereto. The memory 182 may include a volatile memory and/or a non-volatile memory. The program may be stored as the software in the memory 182, and may include, for example, an operating system, a middleware, or an application.

According to an embodiment, the wearable device 1 may include an input device 183, as shown in FIG. 2. The input device 183 may include, for example, a touch sensor, a microphone, and a camera. The wearer may touch a portion of a surface of the wearable device 1 to execute a corresponding function. For example, in a case of listening to music, the wearer may play or stop music by touch interaction. The wearer may make a voice call by using a microphone or may issue an instruction to an artificial intelligence (AI) assistant.

The sensor module 184 may detect an operation state (for example, power or temperature) of the wearable device 1 or an external environment state (for example, a state of the wearer) and generate an electric signal or data value corresponding to the detected state. According to an embodiment, for example, the sensor module 184 may include any one or any combination of any two or more of a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, an illuminance sensor, a position sensor, or a GPS sensor.

The display device 170 may provide information to the outside (for example, the wearer) of the electronic device in a visible manner. The display device 170 may include, for example, a display, a hologram device, or a projector, and a control circuit for controlling the corresponding device.

The display may be a device that displays various contents such as an image, a video, a text, and music, an application execution screen including various contents, a graphic user interface (GUI) screen, and the like. The display may be implemented in various forms such as a liquid crystal display (LCD), a light emitting diode (LED) display, an organic light emitting diode (OLED) display, liquid crystal on silicon (LCoS), digital light processing (DLP), a quantum dot (QD) display panel, a micro electromechanical systems (MEMS) display, and an electronic paper display, but is not limited thereto.

According to an embodiment, the display may be provided as a screen provided at the projector and the glass lens 130. An image projected from the projector may be reflected by the screen and visually recognized by the wearer. According to an embodiment, a prism may be provided between the projector and the screen. Light emitted the projector may be reflected inside the prism and reach the screen. For example, the screen may be formed of a transparent material, such that the screen does not block a front view regardless of whether or not an image is displayed. According to another embodiment, a transparent display may be directly provided on one side of the glass lens 130. For example, an OLED panel does not require a separate light source, and thus has a relatively high transmission. Therefore, the OLED panel is suitable for being provided on one side of the wearable device 1.

According to an embodiment, the wearable device 1 may include the communication module 185. The communication module 185 functions to connect the wearable device 1 to an external device. As a result, the wearable device 1 may receive various types of information required for driving the wearable device 1, update information for updating of the wearable device 1, or the like through the communication module 185. The communication module 185 may perform communication with an external device by various communication methods. Accordingly, the communication module 185 may include various communication modules such as a short-range wireless communication module and a wireless communication module.

Here, the short-range wireless communication module is, for example, a communication module that performs wireless communication with an external device located within a short range, such as a Bluetooth module or a Zigbee module. The wireless communication module is, for example, a module that is connected to an external network to perform communication according to a wireless communication protocol such as Wi-Fi or IEEE. In addition, the wireless communication module may further include a mobile communication module that performs communication by accessing a mobile communication network according to various mobile communication standards such as 3^{rd} generation (3G), 3^{rd} generation partnership project (3GPP), long term evolution (LTE), and 5^{th} generation (5G).

An interface 189 may support one or more specified protocols that may be used for direct or wireless connection between the wearable device 1 and an external device. According to an embodiment, the interface 189 may include, for example, a high definition multimedia interface (HDMI), a universal serial bus (USB) interface, an SD card interface, or an audio interface. The interface 189 may include a connector through which the wearable device 1 may be physically connected to an external device. According to an embodiment, the connector may include, for example, an HDMI connector, a USB connector, an SD card connector, or an audio connector (for example, a headphone connector).

An audio module 187 (which may also be referred to as an audio converter 187) may convert a sound into an electric signal or may convert an electric signal into a sound. According to an embodiment, the audio module 187 may obtain a sound through the input device (for example, a microphone), or may output a sound through an audio output device or an external wearable device 1 (for example, a speaker or headphone) directly or wirelessly connected to the wearable device 1.

The audio output device may output an audio signal to the outside of the wearable device 1. The audio output device may include, for example, a speaker or a receiver. The speaker may be used on general purpose such as reproduction of multimedia or playback, and the receiver may be used to receive an incoming call. According to an embodiment, the receiver may be implemented independently of the speaker or may be implemented as a part of the speaker. According to an embodiment, the audio output device may be disposed at the temple 140 of the wearable device 1 and may thus be positioned near the ear of the wearer when the wearer wears the wearable device 1.

A haptic module 188 (which may also be referred to as a haptic device 188) may convert an electric signal into a mechanical stimulus (for example, vibration or motion) or an electrical stimulus that may be recognized by the wearer through tactile sensation or movement sensation. According to an embodiment, the haptic module 188 may include, for example, a motor, a piezoelectric element, or an electric stimulation device.

According to an embodiment, the wearable device 1 may include at least one solid-state battery 191. The solid-state battery 191 may be a secondary battery to which a solid electrolyte is applied. A battery to which the solid electrolyte is applied has various advantages compared to a battery to which a liquid electrolyte is applied according to the related art.

A lithium ion battery mainly used in a smart device includes a cathode, an anode, and a liquid electrolyte as a medium through which electrons may move between the cathode and the anode. The lithium ion battery further includes a separator provided between the cathode and the anode to prevent a contact between the cathode and the anode. On the other hand, the solid-state battery 191 may include the solid electrolyte instead of the liquid electrolyte, and the solid electrolyte may also serve as the separator.

Since the current lithium ion battery uses the liquid electrolyte, there is a risk of battery damage such as battery expansion due to a temperature change or leakage due to an external shock, and components or devices are needed to increase safety. On the other hand, the solid-state battery including the solid electrolyte is structurally rigid and is thus stable, and even when the electrolyte is damaged, the shape of the solid-state battery may be maintained, which enables further improvement of the safety.

Further, the solid-state battery has a higher energy density than that of the existing lithium ion battery. This is because, as the risk of explosion or fire disappears, safety-related components are omitted and components (for example, a cathode active material or an anode active material) that can increase the capacity of the battery can be provided in the place of the safety-related components.

A battery to which a solid electrolyte is applied outputs high power for its size. Therefore, the solid-state battery 191 may have excellent output efficiency even when the size of the solid-state battery 191 is small. Therefore, the degree of freedom in designing the structure of the wearable device 1 may be greatly improved. For example, the wearable device 1 having a small size may have a battery with a sufficient capacity without impairing device performance or appearance by applying the solid-state battery 191.

The solid-state battery 191 may remove an unstable transient response generated at the moment when power is supplied to the electronic component or power is cut off. In general, a voltage may be dropped or raised at the moment when a single battery supplies power to multiple electronic components and supplies power a specific electronic component, and at the moment when power is cut off, which may result in damage of the electronic component or the battery. On the other hand, according to an embodiment, the solid-state battery 191 may prevent or significantly suppress a phenomenon that a voltage is momentarily dropped (or raised), which may contribute to an increase in lifetime of the battery or the electronic component.

According to an embodiment, one or more solid-state batteries 191 may be combined as one battery cell (for example, a battery cell 192 of FIG. 4) and supply power to a specific electronic component. The battery cell formed of the one or more solid-state batteries 191 may provide various output voltages or charge capacities according to a manner in which the solid-state batteries 191 are connected.

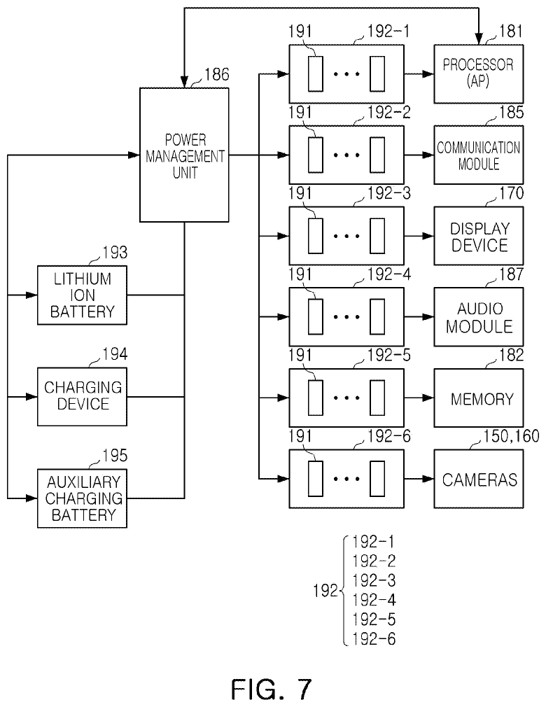

According to an embodiment, the solid-state batteries 191 may be divided into two or more battery cells supplying power to a plurality of electronic components independently of each other. According to an embodiment, the wearable device 1 may include various electronic components and a plurality of battery cells (for example, the battery cells 192 of FIG. 7) that are allocated to the electronic components, respectively, and each include at least one solid-state battery 191. The battery cells may have different charge capacities. In this disclosure, the charge capacity may be an electric capacity or a charge amount that the battery cell may have, and may be a nominal capacity at 25° C. and 1 atmospheric pressure. A battery cell having a large charge capacity may be connected to a component that consumes a large amount of power, thereby facilitating power management.

According to an embodiment, operating voltages of the battery cells may be different from each other. In this disclosure, the operating voltage may be an average operating voltage in a case of the battery cell being discharged at a room temperature and a normal pressure, and may be a nominal voltage at 25° C. and 1 atmospheric pressure. For example, a battery cell corresponding to a required voltage of the electronic component provided in the wearable device 1 may be provided according to a manner in which the solid-state batteries are combined, which may reduce power consumed in a power circuit or the like.

According to an embodiment, the battery cells may be designed to have an operating voltage optimized for an environment in which a specific component, such as a display, is used. For example, the operating voltage of the battery cell directly connected to the application program processor 181 (AP) may be relatively high, and a battery cell having a general operating voltage may be applied as a battery cell connected to a main board 141. In this case, the degree of freedom in designing the structure of the wearable device 1 is increased, and a process such as altering a voltage is minimized to significantly improve efficiency in using electricity.

Different capacities or operating voltages of the battery cells may be implemented by varying the number of solid-state batteries 191 included in each battery cell or varying a connection form of the solid-state batteries 191. For example, in a case in which multiple solid-state batteries 191 having the same specification are connected in series, an output voltage is increased. As another example, as the number of connected batteries is increased, the capacity of the cell is increased.

FIG. 3 illustrates the board 141 provided in the temple 140 and the electronic components mounted on the board 141 according to an embodiment.

Referring to FIG. 3, the wearable device 1 may include the board 141 in the temple 140, and the battery cell 192 including one or more solid-state batteries 191 may be mounted on a surface of the board 141 and/or inside the board 141.

According to an embodiment, the solid-state battery may be disposed in any region of the board 141. For example, after the processor 181, an antenna module, or the like, is appropriately arranged on the board, and the solid-state batteries 191 may be disposed in the remaining space. Since each of the solid-state batteries 191 has a relatively small size, the remaining space of the board 141 may be efficiently filled with the solid-state batteries 191. Accordingly, the size of the temple 140 may be kept relatively small, and the wearable device 1 may receive power necessary for driving (for example, a camera function, a display function, or an audio function) of the wearable device 1 from the solid-state batteries 191.

According to an embodiment, the solid-state battery 191 may be disposed around the electronic component to which the solid-state battery 191 is allocated. For example, the solid-state batteries 191 may be mounted on or inside the board 141 and supply power to the surrounding electronic components.

In general, since each electronic component using one battery, the circuit board 141, and an electric wiring, and the like are connected, an impedance varies due to a parasitic component, and finally, a voltage supplied to the electronic component may be decreased. According to an embodiment, the solid-state battery 191 is disposed close to the electronic component, which may significantly reduce a voltage loss resulting from the parasitic component such as the electric wiring.

FIG. 4 illustrates connection between the plurality of solid-state batteries 191 and the electronic component, according to an embodiment.

Referring to FIG. 4, multiple solid-state batteries 191 may be connected in series and in parallel to form one battery cell 192, and the battery cell 192 may supply power to the processor 181. In the illustrated embodiment, eight solid-state batteries 191 are connected in series and in parallel and supply power to the processor 181. The illustrated embodiment is only an example, and according to other embodiments, the number, a connection method, or a power supply target of the solid-state batteries 191 may vary.

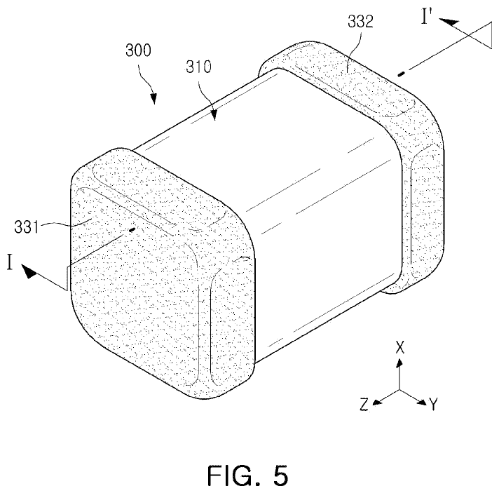

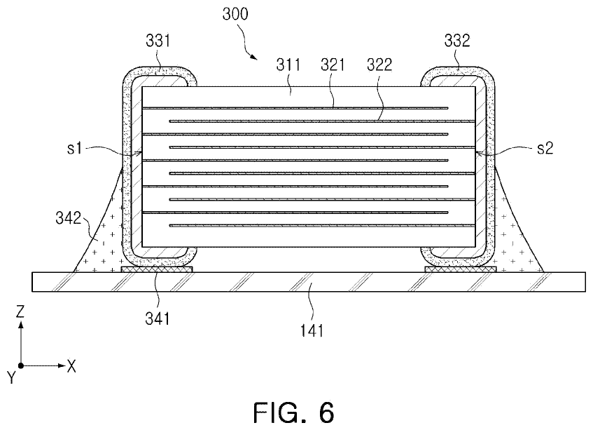

FIG. 5 illustrates a solid-state battery 300, according to an embodiment. FIG. 6 is a cross-sectional view taken along line I-I′ of FIG. 5. The solid-state battery 300 illustrated in FIGS. 5 and 6 is an example of the solid-state battery 191 described with reference to FIGS. 1 through 4.

Referring to FIGS. 5 and 6, the solid-state battery 300 may include: a body 310 including a solid electrolyte layer 311; a cathode 321 and an anode 322 disposed such that the solid electrolyte layer 311 is interposed between the cathode 321 and the anode 322; a first external electrode 331; and a second external electrode 332. The first external electrode 331 is disposed on one surface of the body 310 and is connected to the cathode 321. The second external electrode 332 is disposed on the other surface of the body 310 opposite to the one surface and connected to the anode 322.

According to an embodiment, the solid-state battery 300 may be mounted on the board 141 by using a method such as soldering, laser fusion, ultrasonic fusion, or a solder paste method. For example, the solid-state battery 300 may be soldered (342) on the board 141 so that the first and second external electrodes 331 and 332 are attached to conductive pads 341 disposed on the board 141.

In an example, a cathode active material contained in the cathode 321 is not particularly limited as long as a sufficient capacity may be secured. For example, the cathode active material may include any one or any combination of any two or more of lithium cobalt oxide, lithium nickel cobalt manganese oxide, lithium nickel cobalt aluminum oxide, lithium iron phosphate, and lithium manganese oxide, but is not limited thereto, and all cathode active materials available in the corresponding technical field may be used.

The cathode active material may be, for example, a compound expressed by the following chemical formulae: LiaAl-bMbD2 (0.90≤a≤1.8 and 0≤b≤0.5); LiaEl-bMbO2-cDc (0.90≤a≤1.8, 0≤b≤0.5, and 0≤c≤0.05); LiE2-bMbO4-cDc (0≤b≤0.5 and 0≤c≤0.05); LiaNi1-b-cCobMcDα(0.90≤a≤1.8, 0≤b≤0.5, 0≤c≤0.05, and 0<α≤2); LiaNi1-b-cCobMcO2-αXα(0.90≤a≤1.8, 0≤b≤0.5, 0≤c≤0.05, and 0<α<2); LiaNi1-b-cC0b McO2-αX2 (0.90≤a≤1.8, 0≤b≤0.5, 0≤c≤0.05, and 0<α<2); LiaNi1-b-cMnbMcDα (0.90≤a≤1.8, 0≤b≤0.5, 0≤c≤0.05, and 0<α≤2); LiaNi1-b-cMnbMcO2-αXα (0.90≤a≤1.8, 0≤b≤0.5, 0≤c≤0.05, and 0<α<2); LiaNi1-b-cMnbMcO2-αX2 (0.90≤a≤1.8, 0≤b≤0.5, 0≤c≤0.05, and 0<α<2); LiaNibEcGdO2 (0.90≤a≤1.8, 0≤b≤0.9, 0≤c≤0.5, and 0.001≤d≤0.1); LiaNibCocMndGeO2 (0.90≤a≤1.8, 0≤b≤0.9, 0≤c≤0.5, 0≤d≤0.5, and 0.001≤e≤0.1); LiaNiGbO2 (0.90≤a≤1.8 and 0.001≤b≤0.1); LiaCoGbO2 (0.90≤a≤1.8 and 0.001≤b≤0.1); LiaMnGbO2 (0.90≤a≤1.8 and 0.001≤b≤0.1); LiaMn2GbO4 (0.90≤a≤1.8 and 0.001≤b≤0.1); QO2; QS2; LiQS2; V2O5; LiV2O2; LiRO2; LiNiVO4; Li(3−f)J2(PO4)3 (0≤f≤2); Li(3−f)Fe2(PO4)3 (0≤f≤2); and LiFePO4. In the chemical formulae, A represents Ni, Co, or Mn, M represents Al, Ni, Co, Mn, Cr, Fe, Mg, Sr, V, or a rare-earth element, D represents O, F, S, or P, E represents Co or Mn; X represents F, S, or P, G represents Al, Cr, Mn, Fe, Mg, La, Ce, Sr, or V, Q represents Ti, Mo, or Mn; R represents Cr, V, Fe, Sc, or Y, and J represents V, Cr, Mn, Co, Ni, or Cu.

The cathode active material may also be LiCoO2, LiMnxO2x (x=1 or 2), LiNi1-xMnxO2x (0<x<1), LiNi1-x-yCoxMnyO2 (0≤x≤0.5 and 0≤y≤0.5), LiFePO4, TiS2, FeS2, TiS3, or FeS3, but is not limited thereto.

The cathode 321 of the solid-state battery 300 according to this disclosure may selectively include a conductive material, a binder, and a cathode current collector. The conductive material is not particularly limited as long as it has conductivity without causing a chemical change in the solid-state battery 300. For example, a conductive material including graphite such as natural graphite or artificial graphite, a carbon-based material such as carbon black, acetylene black, Ketjen black, channel black, furnace black, lamp black, or thermal black, a conductive fiber such as a carbon fiber or a metallic fiber, carbon fluoride, metallic powder such as aluminum powder or nickel powder, a conductive whisker such as zinc oxide or potassium titanate, a conductive metal oxide such as titanium oxide, and a polyphenylene derivative, and the like may be used.

The content of the conductive material may be 1 to 10 parts by weight, for example, 2 to 5 parts by weight based on 100 parts by weight of the cathode active material. In a case in which the content of the conductive material is within the aforementioned range, a finally obtained electrode may have an excellent conductivity characteristic.

The binder may be used to improve a coupling force of the active material, the conductive material, and the like. The binder may include polyvinylidene fluoride, polyvinyl alcohol, carboxymethyl cellulose (CMC), starch, hydroxypropyl cellulose, regenerated cellulose, polyvinyl pyrrolidone, polytetrafluoroethylene, polyethylene, polypropylene, an ethylene-propylene-diene terpolymer (EPDM), sulfonated EPDM, styrene-butadiene rubber, fluorinated rubber, and various copolymers, but is not limited thereto. The content of the binder may be 1 to 50 parts by weight, for example, 2 to 5 parts by weight based on 100 parts by weight of the cathode active material. In a case in which the content of the binder is within the aforementioned range, the active material layer may have a higher coupling force.

A porous material having a net structure or mesh structure may be used as the cathode current collector. For example, a porous metal plate formed of stainless steel, nickel, or aluminum may be used as the cathode current collector. However, the cathode current collector is not limited to the foregoing examples. Further, the cathode current collector may be coated with an oxidation-resistant metal or alloy coating film to prevent oxidation.

The cathode 321 applied to the solid-state battery 300 may be prepared in a manner in which a composition containing the cathode active material is directly applied onto the cathode current collector containing a metal such as copper and then dried. Alternatively, the cathode 321 may be prepared in a manner in which a cathode active material composition is cast on a separate support and hardened, and in this case, a separate cathode current collector does not have to be provided.

The anode 322 included in the solid-state battery 300 may contain a generally used anode active material. A carbon-based material, silicon, silicon oxide, a silicon-based alloy, a silicon-carbon-based material complex, tin, a tin-based alloy, a tin-carbon complex, a metal oxide, or a combination thereof may be used as the anode active material. The anode active material may include a lithium metal and/or a lithium metal alloy.

The lithium metal alloy may include lithium and a metal or metalloid that may be alloyed with lithium. For example, the metal or metalloid that may be alloyed with lithium may be Si, Sn, Al, Ge, Pb, Bi, Sb, a Si—Y alloy (Y is an alkali metal, an alkali earth metal, an element of Groups 13 to 16, a transition metal, a rare earth element, or a combination thereof except for Si), a Sn—Y alloy (Y is an alkali metal, an alkali earth metal, an element of Groups 13 to 16, a transition metal, a transition metal oxide such as lithium titanium oxide (Li4Ti5O12), a rare earth element, or a combination thereof except for Sn), and MnOx (0<x≤2). Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof.

Further, an oxide of the metal or metalloid that may be alloyed with lithium may be lithium titanium oxide, vanadium oxide, lithium vanadium oxide, SnO₂, SiOx (0<x<2), or the like. For example, the anode active material may contain one or more elements selected from the elements of Groups 13 to 16 of a periodic table of the elements. For example, the anode active material may contain one or more elements selected from Si, Ge, and Sn.

The carbon-based material may be crystalline carbon, amorphous carbon, or a mixture thereof. The crystalline carbon may be graphite such as natural graphite or artificial graphite that are in an amorphous, plate, flake, spherical, or fibrous form. The amorphous carbon may be soft carbon (carbon sintered at a low temperature), hard carbon, a mesophase pitch carbide, sintered corks, graphene, carbon black, fullerene soot, a carbon nanotube, a carbon fiber, or the like, but is not limited thereto.

Silicon may be selected from Si, SiOx (0<x<2, for example, 0.5 to 1.5), Sn, SnO₂, a silicon-containing metal alloy, and a mixture thereof. For example, the silicone-containing metal alloy may contain silicon and at least one of Al, Sn, Ag, Fe, Bi, Mg, Zn, In, Ge, Pb, or Ti.

The anode may be prepared by almost the same process as the cathode preparing process described above except that the anode active material is used instead of the cathode active material.

According to an embodiment, the solid electrolyte layer may be any one or any combination of any two or more of a garnet-type solid electrolyte layer, a NASICON-type solid electrolyte layer, a LISICON-type solid electrolyte layer, a perovskite-type solid electrolyte layer, and a LiPON-type solid electrolyte layer.

The garnet-type solid electrolyte layer may be a layer containing lithium lanthanum zirconium oxide (LLZO) represented by LiₐLa_{b}Zr_{c}O₁₂ such as Li₇La₃Zr₂O₁₂, and the NASICON-type solid electrolyte layer may be a layer containing lithium aluminum titanium phosphate (LATP) represented by Li₁₊ₓAlₓTi₂₋ₓ(PO₄)₃ (0<x<1) in which Ti has been introduced into a Li₁₊ₓAlₓM₂₋ₓ(PO₄)₃(LAMP) type compound (where 0<x<2, and M=Zr, Ti, or Ge), lithium aluminum germanium phosphate (LAGP) represented by Li₁₊ₓAlₓGe₂₋ₓ(PO₄)₃ (0<x<1) such as Li_{1.3}Al_{0.3}Ti_{1.7}(PO₄)₃ into which an excessive amount of lithium has been introduced, and/or lithium zirconium phosphate (LZP) represented by LiZr₂(PO₄)₃.

In addition, the LISICON-type solid electrolyte layer may be a layer containing a solid solution oxide including Li₄Zn(GeO₄)₄, Li₁₀GeP₂O₁₂(LGPO), Li_{3.5}Si_{0.5}P_{0.5}O₄, Li_{10.42}Si(Ge)_{1.5}P_{1.5}Cl_{0.08}O_{11.92}, or the like, represented by xLi₃AO₄-(1−x)Li₄BO₄ (A=P, As, V, or the like, and B═Si, Ge, Ti, or the like), and a solid solution sulfide including Li₂S—P₂S₅, Li₂S—SiS₂, Li₂S—SiS₂—P₂S₅, Li₂S—GeS₂, or the like, represented by Li₄₋ₓM_{1-y}M′_{y}′S₄ (M=Si or Ge, and M′=P, Al, Zn, or Ga).

In an example, ionic conductivity of the solid electrolyte applied to the solid-state battery 300 may be 10⁻³ S/cm or more. The ion conductivity may be a value measured at a temperature of 25° C. The ion conductivity may be 1×10⁻³ S/cm or more, 2×10⁻³ S/cm or more, 3×10⁻³ S/cm or more, 4×10⁻³ S/cm or more, or 5×10⁻³ S/cm or more, and an upper limit of the ion conductivity is not particularly limited, but may be, for example, 1×100 S/cm. When using a solid electrolyte that satisfies the ion conductivity within the above ranges, the solid-state battery 300 may exhibit a relatively high output.

The solid-state battery 300 may include a cover portion (not illustrated). The cover portion may be disposed on a part of an outer surface of the body 310. The cover portion may be formed of an insulating material, and may be formed by attaching a film such as a polymer resin or by applying a ceramic material on the body and then sintering the ceramic material.

In the solid-state battery 300, the first external electrode 331 and the second external electrode 332 may be disposed on opposite surfaces of the body in a first direction (X direction). The first external electrode 331 may be connected to the cathode 321, and the second external electrode 332 may be connected to the anode 322.

The first external electrode 331 and the second external electrode 332 may contain a conductive metal and glass. The conductive metal may be, for example, one or more conductive metals of copper (Cu), nickel (Ni), tin (Sn), palladium (Pd), platinum (Pt), gold (Au), silver (Ag), tungsten (W), titanium (Ti), lead (Pb), and alloys thereof, but is not limited thereto. In addition, the glass contained in the first external electrode 331 and the second external electrode 332 may have a composition in which oxides are mixed. The glass may be, for example, any one or any combination of any two or more of silicon oxide, boron oxide, aluminum oxide, transition metal oxide, alkali metal oxide, and alkaline earth metal oxide, but is not limited thereto. The transition metal may be any one of zinc (Zn), titanium (Ti), copper (Cu), vanadium (V), manganese (Mn), iron (Fe), and nickel (Ni), the alkali metal may be any one of lithium (Li), sodium (Na), and potassium (K), and the alkaline earth metal may be any one or any combination of any two or more of magnesium (Mg), calcium (Ca), strontium (Sr), and barium (Ba).

A method of forming the first external electrode 331 and the second external electrode 332 is not particularly limited. For example, the body 310 may be dipped into a conductive paste containing the conductive metal and the glass, or the conductive paste may be printed on a surface of the body 310 by a screen-printing method or a gravure printing method to form the external electrodes. In addition, various methods such as applying the conductive paste on the surface of the body 310 or transferring a dry film formed by drying the conductive paste onto the body may be used, but the method of forming the first external electrode 331 and the second external electrode 332 is not limited thereto.

According to another embodiment, the solid-state battery 300 may include two or more cathodes 321 and two or more anodes 322, and a plurality of cathodes 321, a solid electrolyte layer, and a plurality of anodes 322 may be sequentially stacked. Referring to FIG. 6, the plurality of cathodes 321 and the plurality of anodes 322 may be arranged to face each other while having the solid electrolyte layer 311 interposed therebetween. The cathode 321 may be exposed from a first surface S1 of the body 310, and a portion of the cathode 321 exposed from the first surface S1 of the body 310 may be connected to the first external electrode 331. The anode 322 may be exposed from a second surface S2 of the body 310, and a portion of the anode 322 exposed from the second surface S2 of the body 310 may be connected to the second external electrode 332. As described above, in a case in which the plurality of cathodes 321 and the plurality of anodes 322 facing each other are included, the solid-state battery 300 may implement a high capacity, a high energy density, and/or a high current.

FIG. 7 is a block diagram illustrating power management using the solid-state battery 191, according to an embodiment.

According to an embodiment, the wearable device 1 may include a power management unit (PMU) 186 (which may also be referred to as a power manager 186) and the battery cells 192.

The power management unit 186 may perform management so that the battery 190 is charged or discharged with power necessary for operation of the wearable device 1, and may transform power to be suitable for supply to the battery 190 when power is supplied. Here, the power management unit 186 may be implemented by a power management integrated circuit (PMIC), and may include the processor 181 controlling operations for power management, a resistor for current control, and the like. However, in this disclosure, detailed components of the power management unit 186 are not distinguished and collectively referred to as the “power management unit 186” for convenience of explanation. In this disclosure, a case in which the power management unit 186 performs a power control operation is described. However, this is for convenience of explanation, and the power control operation may be performed by a processor separate from the power management unit 186.

The wearable device 1 may include the plurality of solid-state batteries 191, and at least one solid-state battery 191 may be configured to supply power only to a specific electronic component. For example, some of the solid-state batteries 191 may supply power to the processor 181 and the others may supply power to a camera module.

As one or more solid-state batteries independently supplying power to each of the electronic components are provided, the wearable device 1 may stably supply power to each of the electronic components. Generally, in a case in which the wearable device 1 uses one battery, an operation of a specific electronic component may cause a change in voltage supplied to another electronic component, which is problematic. This is because a circuit connected to the battery is changed depending on activated electronic components, which changes an impedance of the entire circuit. Therefore, a separate circuit is required to solve such a problem. However, according to an embodiment in this disclosure, a specific solid-state battery 191 independently supplies power to a specific electronic component, and thus, power may be stably supplied to the corresponding electronic component regardless of power supply to another electronic component.

A single battery employed in the electronic device according to the related art provides a single output (for example, a single output voltage). Therefore, a power rectifying element or circuit (low dropout (LDO), boosting circuit, or the like) needs to be provided between the battery and the electronic components to appropriately provide power to each electronic component when supplying power to various electronic components. On the other hand, according to embodiments disclosed herein, the battery cells 192 each including at least one solid-state battery 191 may be independently allocated to the electronic components, and thus, an element for dropping a voltage need not be provided between the battery and the electronic components. For example, in a case of a general lithium ion battery, a low-voltage rectifying circuit needs to be additionally provided to drive an image sensor using power of 2.8 V, 1.8 V, or 1.2 V. On the other hand, the solid-state batteries 191 may be combined in series and/or in parallel according to an output value, and supply a voltage of 2.8 V, 1.8 V, or 1.2 V to the image sensor without the rectifying circuit.

Referring to FIG. 7, according to an embodiment, the wearable device 1 may include the battery cells 192 allocated to the electronic components (for example, the processor 181, the display device 170, the audio module 187, a memory 182, and the cameras 150 and 160), respectively. For example, the battery cells 192 may include a first battery cell 192-1, a second battery cell 192-2, a third battery cell 192-3, a fourth battery cell 192-4, a fifth battery cell 192-5, and a sixth battery cell 192-6 allocated to the processor 181, the communication module 185, the display device 170, the audio module 187, the memory 182, and the first and second cameras 150 and 160, respectively.

Each of the battery cells 192 may include at least one solid-state battery 191. Each of the battery cells 192 may include a plurality of solid-state batteries 191 connected in series or in parallel. Each of the battery cells 192 may provide an output suitable for an electronic component to which the corresponding battery cell 192 is allocated. For example, in a case in which the processor 181 requires a first voltage, the solid-state batteries 191 included in the first battery cell 192-1 may be combined so that the first battery cell 192-1 outputs the first voltage. In a case in which the first and second cameras 150 and 160 require a second voltage, the solid-state batteries 191 included in the sixth battery cell 192-6 may be combined differently from the solid-state batteries 191 included in the first battery cell 192-1 to provide the second voltage.

According to an embodiment, the wearable device 1 may further include an additional battery. For example, the wearable device 1 may include the lithium ion battery 193. The lithium ion battery 193 may be used to assist or substitute for the solid-state batteries 191 or the battery cells 192. For example, in a case in which the state of charge of the first battery cell 192-1 is low, the lithium ion battery 193 may supply power to the processor 181 together with the first battery cell 192-1. As another example, in a case in which the first battery cell 192-1 is almost empty, the lithium ion battery 193 may supply power to the processor 181 instead of the first battery cell 192-1.

According to an embodiment, the wearable device 1 may include a charging device 194. The lithium ion battery 193 or the solid-state battery 191 may be charged by the charging device 194. The charging device 194 may include, for example, a USB port. According to an embodiment, the solid-state battery 191 may be charged by the power management unit 186, rather than being directly charged by the charging device 194. For example, the power management unit 186 may discharge the liquid ion battery 193 to charge the solid-state battery 191. According to an embodiment, the wearable device 1 may further include an auxiliary charging battery 195. The auxiliary charging battery 195 may be charged by the charging device 194.

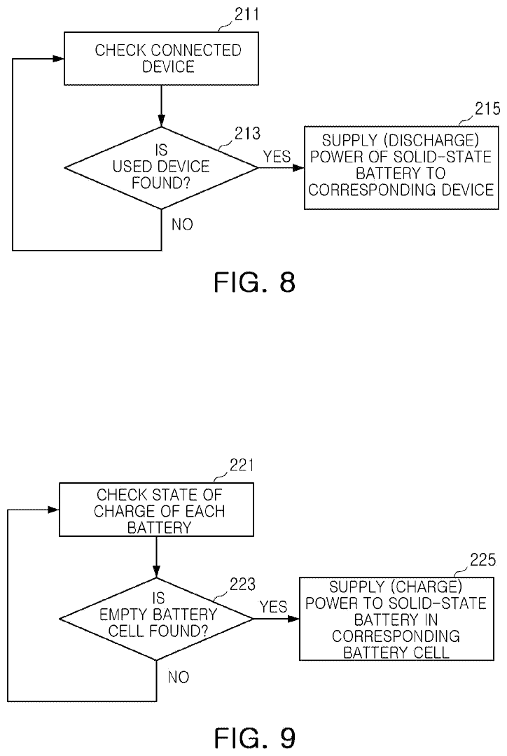

FIG. 8 is a flowchart illustrating a discharge of the solid-state battery 191 corresponding to a used device, according to an embodiment.

According to an embodiment, the power management unit 186 may be configured to selectively supply power to the electronic components based on the activation of the electronic components. For example, referring to FIG. 7, the power management unit 186 may be configured to selectively discharge a battery cell that is allocated to an activated one of the electronic components among the plurality of battery cells 192. Referring to FIG. 8, the power management unit 186 may supply power to a specific electronic component based on activation of a function related to the corresponding electronic component. In the wearable device 1, the power management unit 186 may check a connected device in operation 211, and in a case in which it is determined that the device is used in operation 213, the wearable device 1 may supply power to the corresponding device by discharging the solid-state battery 191 allocated to the corresponding device in operation 215.

FIG. 9 is a flowchart illustrating a charge of the solid-state battery 191 based on the state of charge, according to an embodiment.

According to an embodiment, the battery cells 192 may be individually charged or discharged. The power management unit 186 may collectively charge all the battery cells 192 or selectively charge some of the battery cells 192.

Referring to FIG. 9, the power management unit 186 checks the state of charge of each battery cell 192 in operation 221, and in a case in which an empty battery cell is found in operation 223, the solid-state batteries 191 in the specific battery cell whose state of charge is low may be charged in operation 225. According to another embodiment, the power management unit 186 may charge a specific battery cell in a case in which the state of charge of the corresponding battery cell is lower than a designated value.

According to an embodiment, the power management unit 186 may preferentially charge the battery cell 192 whose state of charge is low. For example, in a case in which, at a specific point in time, the state of charge of the battery cell 192 that is allocated to the processor 181 is 30%, and the state of charge of the battery cell 192 that is allocated to the first and second cameras 150 and 160 is 80%, the power management unit 186 may preferentially charge the battery cell 192 that is allocated to the processor 181. The battery cell 192 may be charged at a relatively high speed by preferentially charging the battery cell 192 that needs to be charged.

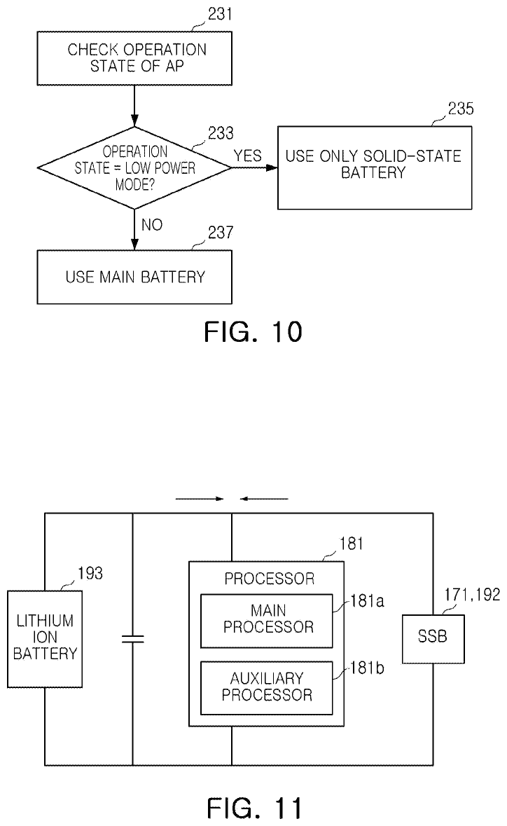

FIG. 10 is a flowchart illustrating selective use of a main battery based on an operation state of the processor 181 according to an embodiment.

According to an embodiment, the wearable device 1 may further include the main battery (for example, the lithium ion battery 193 of FIG. 2) in addition to the solid-state battery 191. The main battery may have a higher capacity than that of the battery cell 192. For example, the main battery may include the lithium ion battery 193. As another example, the main battery may include a battery cell including a relatively large number of solid-state batteries 191.

The power management unit 186 may operate the wearable device 1 by simultaneously or individually discharging the main battery and the battery cell 192. Referring to FIG. 10, in operation 231 and operation 233, the power management unit 186 may determine whether the processor 181 is in a low power mode (for example, a sleep mode or a standby mode) or in a normal operation mode, and may determine a battery for supplying power to the electronic components based on the determination result. For example, in a case in which the processor 181 is in the standby mode or the sleep mode, the power management unit 186 may supply power to each electronic component in operation 235, by only using the solid-state battery 191. As another example, in a case in which the processor 181 is in the normal operation mode, the power management unit 186 may supply power to each electronic component in operation 237, by using the main battery. As another example, in a case in which the processor 181 is in the normal operation mode, the power management unit 186 may supply power to each electronic component in operation 237, by using both the main battery and the solid-state battery 191.

FIG. 11 illustrates a circuit supplying power to the processor 181, according to an embodiment.

Referring to FIG. 11, according to an embodiment, the processor 181 may include a main processor 181a and an auxiliary processor 181b. The auxiliary processor 181b consumes less power than the main processor 181a, and in a case in which the wearable device 1 is in the standby mode or the sleep mode, the main processor 181a may be inactivated and only the auxiliary processor 181b may be activated. According to an embodiment, the power management unit 186 may be configured to determine whether to discharge the lithium ion battery 193 based on whether the main processor 181a is activated. In a case in which the wearable device 1 is in the standby mode or the sleep mode, the power management unit 186 may supply power to the auxiliary processor 181b by discharging the battery cell 192. In a case in which the wearable device 1 is in the normal operation mode, both the lithium ion battery 193 and the solid-state battery 191 may supply power to the main processor 181a and the auxiliary processor 181b. According to an embodiment, the use of the lithium ion battery 193 and the solid-state battery 191 may be switched depending on the operation mode of the processor 181, thereby increasing lifetime and efficiency of the main battery.

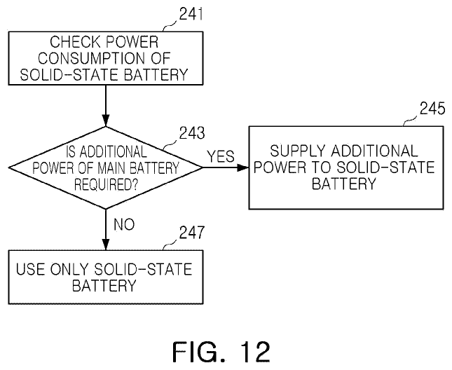

FIG. 12 is a flowchart illustrating a power supply method in which the main battery (for example, the lithium ion battery 193 of FIG. 7) is used to assist the solid-state battery 191, according to an embodiment.

According to an embodiment, the power management unit 186 may be configured to determine whether to discharge the lithium ion battery 193 based on whether the processor (for example, the processor 181 of FIG. 7) is activated. Referring to FIG. 12, according to an embodiment, the power management unit 186 may check a power consumption amount of the solid-state battery 191 that supplies power to a specific electronic component, in operation 241, and may determine whether to additionally use the main battery to supply power to the corresponding electronic component based on the checked power consumption amount, in operation 243. For example, in a case in which less load is applied to the processor 181, and the power consumption amount of the solid-state battery 191 that is allocated to the processor 181 is thus not large, only the solid-state battery 191 that is allocated to the processor 181 may supply power to the processor 181 in operation 247. As another example, in a case in which the wearable device 1 executes multiple functions, and a high load is applied to the processor 181, the main battery may supply power to the processor 181 together with the solid-state battery 191 in operation 245.

According to another embodiment, the power management unit 186 may check a power consumption amount of a specific solid-state battery 191, and may determine whether or not to additionally use the main battery to charge the corresponding solid-state battery 191 based on the checked power consumption amount. For example, in a case in which a high load is applied to the processor 181, the main battery may supply power to (that is, charge) the solid-state battery 191 while the solid-state battery 191 supplies power to the processor 181.

According to an embodiment, the power management unit 186 may measure a discharge speed by monitoring the state of charge of each of multiple battery cells 192, and determine whether or not the discharge speed exceeds a threshold value corresponding to the battery cell 192. According to an embodiment, in a case in which it is determined that the discharge speed of the solid-state battery 191 exceeds a reference value, the power management unit 186 may charge the corresponding solid-state battery 191 by discharging the main battery or may control the main battery to supply power to a specific electronic component together with the solid-state battery 191.

According to an embodiment, the power management unit 186 may control the battery cells 192 to supply or receive power to or from each other. For example, referring to FIG. 7, the first battery cell 192-1 that is allocated to the processor 181 and the sixth battery cell 192-6 that is allocated to the first and second cameras 150 and 160 may supply or receive power to or from each other. For example, in a case in which the state of charge of the first battery cell 192-1 is low, the power management unit 186 may control the corresponding battery cell 192-1 to receive power from the sixth battery cell 192-6 whose state of charge is high. As another example, in a case in which the state of charge of the first battery cell 192-1 is high, the power management unit 186 may control the corresponding battery cell 192-1 to charge the sixth battery cell 192-6 whose state of charge is low.

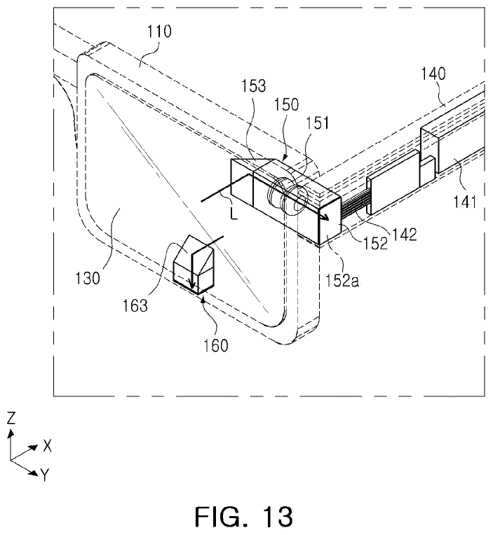

Hereinafter, the first and second cameras 150 and 160 disposed in the wearable device 1 will be described with reference to FIGS. 13 through 22. In a case in which a camera is disposed in the wearable device 1, a thickness of the rim 110 or a thickness of a portion connecting the rim 110 and the temple 140 of the wearable device 1 may be increased by the size of the camera, which may impair the appearance of the wearable device 1.

Particularly, since the image sensor that may obtain a high-resolution image has a relatively large size, in a case in which a camera is disposed so that the imaging surface of the sensor is oriented toward the side in front of the glasses, the appearance of the wearable device 1 is further impaired, the productivity of the wearable device 1 deteriorates, such that the wearer does not constantly use the wearable device 1 in daily life.

FIG. 13 illustrates the first and second cameras 150 and 160 mounted on the wearable device 1 (e.g., glasses) according to an embodiment. FIG. 13 schematically illustrates the first and second cameras 150 and 160 and the electronic components provided on the left side (or one side) of the wearable device 1, and the same or similar components may be provided on the right side (or the other side) of the wearable device.

Referring to FIG. 13, the wearable device 1 may include the first camera 150 disposed at the upper portion of the rim 110. The first camera 150 may be configured to capture an image of the subject positioned in front of the wearable device 1. That is, the first camera 150 may be configured to capture an image of the subject positioned in a direction in which the face of the wearer is oriented.

According to an embodiment, the first camera 150 may include the reflection member 153, at least one first lens 151, and the image sensor 152. The image sensor 152 may be electrically connected to the board 141, and a connector 142 may electrically connect the image sensor 152 and the board 141 to each other. The image sensor 152 may receive power through the connector 142, and may transmit an image signal to another electronic component (for example, an image processor) mounted on the board 141.

According to an embodiment, the reflection member 153 of the first camera 150 may change a direction of light incident from the side in front of the wearable device 1, toward the imaging surface 152a of the image sensor 152. For example, the reflection member 153 may reflect light incident from the side in front of the wearable device 1 in the +X direction toward the image sensor 152 in the +Y direction. Accordingly, the image sensor 152 may be disposed so that the imaging surface 152a is oriented toward the lateral side of the wearable device 1 (that is, in the Y direction).

According to an embodiment, the wearable device 1 may include the second camera 160 disposed at the lower portion of the rim 110. The second camera 160 may be configured to capture an image of the eye of the wearer. The gaze of the wearer is changed depending on the direction of the eye, and the wearable device 1 may determine which direction or which point to which the gaze of the wearer is directed by using the second camera 160.

According to an embodiment, the second camera 160 may include the reflection member 163 and the image sensor 162. At least one second lens may be disposed between the reflection member 163 and the image sensor 162. The image sensor 162 may be electrically connected to the board 141, and a connector may electrically connect the image sensor 162 and the board 141 to each other. Although not illustrated, the connector may be accommodated in the rim 110 of the wearable device 1, and may electrically connect the second camera 160 and the board 141 (or the electronic component mounted on the board 141) to each other.

According to an embodiment, the reflection member 163 of the second camera 160 may change a direction of light incident from behind the wearable device 1, toward the image sensor 162. For example, the reflection member 153 may reflect light incident from the side in front of the wearable device 1 in the −X direction toward the image sensor 152 in the −Z direction. Accordingly, the image sensor 152 may be disposed to be oriented toward the upper side of the wearable device 1 (that is, in the +Z direction).

According to an embodiment, the reflection member 153 or 163 may be partially opaque. For example, a surface (for example, a triangular side surface of the reflection member 153 or 163 in the illustrated embodiment) other than an incident surface, an emission surface, and a reflection surface of the reflection member 153 or 163 does not have to transmit light. For example, a side surface of the prism may be covered with an opaque material.

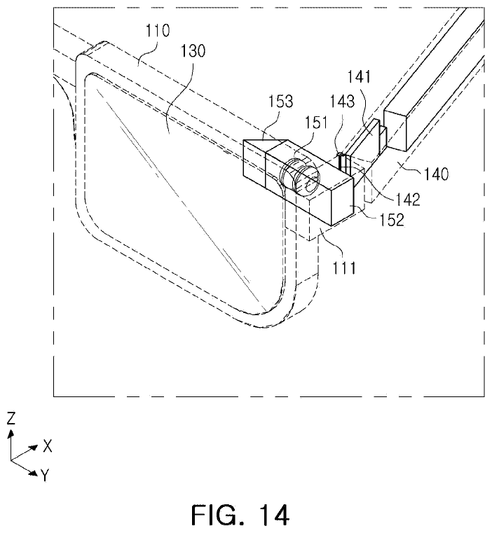

FIG. 14 illustrates a hinge connecting the rim 110 and the temple 140 of the wearable device 1, according to an embodiment.

According to an embodiment, the temple 140 may extend from the rim 110 and may be hung on the ear of the user. The temple 140 may be foldably coupled to the rim 110. Referring to FIG. 14, the temple 140 of the wearable device 1 may be foldably coupled to the rim 110 (or a portion 111 extending from one side of the rim 110). The temple 140 may be foldably mounted, thereby facilitating storage or carrying. For example, the temple 140 may be connected to the rim 110 through a hinge 143.

According to an embodiment, as the temple 140 is folded and unfolded, an electrical path connecting the image sensor 152 and the board 141 may also be folded or unfolded. According to an embodiment, the connector 142 connecting the image sensor 152 and the board 141 to each other may be implemented by a flexible board 142 to prevent damage caused by folding or unfolding of the temple 140. The flexible board 142 may be naturally folded by rotation of the temple 140, such that the electrical connection between the image sensor 152 and the board 141 may be maintained.

FIG. 15A illustrates a portion of the glass lens 130 that functions as the reflection member, according to an embodiment. FIG. 15B illustrates a portion of the glass lens 130, that functions as the reflection member, according to an embodiment. FIG. 16A is a cross-sectional view taken along line II-II′ of FIG. 15A. FIG. 16B is a cross-sectional view taken along line III-III′ of FIG. 15B.

The reflection member 153 or 163 illustrated in FIGS. 1, 13, 14, and the like may be provided as a part of the glass lens 130. The glass lens 130 may have a reflection surface 131 configured to fold a path of light incident toward the glass lens 130 toward the image sensor 152. A separate coating layer may be applied on the reflection surface 131 to induce total reflection of light. Referring to FIGS. 15A and 16A, the glass lens 130 may include the reflection surface 131. The reflection surface 131 may be formed by machining a part of the glass lens 130. A direction of light incident on the reflection surface 131 from the side in front of the wearable device 1 may be changed toward the image sensor 152. That is, a direction of light incident from the side in front of the wearable device 1 may be changed toward the image sensor 152 without a separate reflection member (for example, the reflection member 153 or 163 of FIG. 13). According to an embodiment, the reflection surface 131 of the glass lens 130 may have a curved surface or a flat surface. For example, the glass lens 130 may have the reflection surface 131 obliquely facing the imaging surface 152a of the image sensor 152.

Referring to FIGS. 15B and 16B, a back surface of the glass lens 130 may be partially machined to provide the reflection surface 131. The glass lens 130 of FIG. 15A has a recess 132 disposed in a front surface thereof, whereas the glass lens 130 of FIG. 15B has the recess 132 disposed in a back surface thereof.

In the illustrated embodiment, the glass lens 130 is partially machined to form the reflection surface 131. According to another embodiment, the reflection surface 131 may be provided by the reflection member 153 or 163 separate from the glass lens 130, and the reflection member 153 or 163 may be seated on the glass lens 130. For example, the glass lens 130 may have a recess 132 machined to correspond to the prism, and the prism may be seated in the recess 132 provided in the glass lens 130.

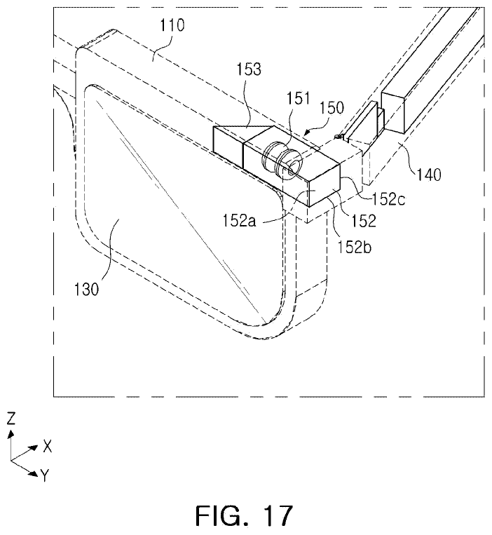

FIG. 17 illustrates a state in which the first camera 150 is disposed at the upper portion of the rim 110, according to an embodiment.

According to an embodiment, the first camera 150 of the wearable device 1 may be embedded in the rim 110. For example, the first camera 150 may be embedded in a portion of the rim 110 that surrounds an upper portion of the glass lens 130. For example, at least some of the reflection member 153, at least one lens 151, or the image sensor 152 may be embedded in a portion of the rim 110 that surrounds the upper portion of the glass lens 130 and extends in the Y direction. Referring to FIG. 17, the camera 150 may include the image sensor 152 whose imaging surface 152a is oriented toward the lateral side of the wearable device 1. According to an embodiment, the imaging surface 152a of the image sensor 152 may have an aspect ratio other than 1, and in this case, the image sensor 152 may be disposed so that a short side 152c corresponds to a height of the image sensor 152 when the wearable device 1 is viewed from the side in front of the wearable device 1. For example, the image sensor 152 may be disposed so that a long side 152b of the imaging surface 152a extends in the X direction and the short side 152c extends in the Z direction.

In a case in which the image sensor 152 is disposed so that the short side 152c corresponds to the height, the thickness of the first camera 150 may be decreased when viewed from the side in front of the wearable device 1, which improves the appearance of the first camera 150. As the thickness of the first camera 150 is decreased, the camera 150 may be accommodated in a portion of the rim 110. Referring to FIG. 17, the camera 150 is accommodated in the upper portion of the rim 110. The upper portion of the rim 110 may have a space for accommodating the first camera 150, and the first camera 150 may be fitted into the space.

In a case in which the first camera 150 is accommodated in the upper portion of the rim 110, at least the reflection member 153 of the first camera 150 may be exposed to the outside of the rim 110. For example, the rim 110 may have an opening that is opened toward the side in front of the wearable device 1 at a position corresponding to the reflection member 153, and light may enter the first camera 150 through the opening. According to an embodiment, a transparent cover may be disposed on the opening to prevent dust from being introduced or improve the appearance.

In the illustrated embodiment, the first camera 150 may be disposed in the rim 110 behind the glass lens 130. In this case, a part of the first camera 150 may be visually recognized from the side in front of the wearable device 1 through the glass lens 130.

FIG. 18 illustrates a state in which the first camera 150 is disposed at the bridge 120 of the wearable device 1, according to an embodiment. FIG. 19 illustrates a state in which two first cameras 150 are disposed at the bridge 120 of the wearable device 1.

Referring to FIG. 18, the frame 105 of the wearable device 1 may include the bridge 120 connecting a pair of rims 110, and the first camera 150 may be at least partially disposed at the bridge 120. According to an embodiment, at least some of the reflection member 153, the lens 151, or the image sensor 152 may be embedded in the bridge 120. For example, the reflection member 153 of the camera 150 may be disposed in an inner region surrounded by the rim 110 behind the left glass lens 130, and the image sensor 152 or the lens 151 may be disposed behind the bridge 120. The image sensor 152 may be disposed toward the side in the −Y direction (or the +Y direction), and the reflection member 153 may change a direction of light incident from the side in front of the wearable device 1 toward the image sensor 152. According to an embodiment, as the image sensor 152 is disposed at the bridge 120, an electrical wiring connecting the image sensor 152 to the board 141 in the temple 140 may be disposed in the rim 110. According to an embodiment, the first reflection member 153 may be at least partially disposed in a region surrounded by the rim 110. For example, the reflection surface of the first reflection member 153 may be positioned in the region surrounded by the rim 110.

Referring to FIG. 19, according to an embodiment, two first cameras, a left camera 150L and a right camera 150R, may be disposed at the bridge 120. A left image sensor 152L of the left camera 150L and a right image sensor 152R of the right camera 150R may be oriented in different directions. That is, imaging surfaces of the left and right image sensors 152L and 152R are oriented in different directions. For example, the imaging surface of the left image sensor 152L may be oriented toward the left side, and the imaging surface of the right image sensor 152R may be oriented toward the right side.

According to an embodiment, the left and right cameras 150L and 150R may share the board 141 on which the left and right image sensors 152L and 152R are mounted. For example, the left and right image sensors 152L and 152R may be disposed on one surface and the other surface of the board 141, respectively.

Further, in a case in which the left and right image sensors 152L and 152R are disposed on opposite surfaces of one board 141, the board 141 may be moved in a direction orthogonal to the optical axis, such that image stabilization of both of the cameras 150L and 150R may be implemented at once.

According to an embodiment, left and right reflection members 153L and 153R may be at least partially disposed in a region surrounded by the rim 110. According to an embodiment, the left and right reflection members 153L and 153R that initially receive light in the left and right cameras 150L and 150R, respectively, may be spaced apart from each other. Therefore, the wearable device 1 may obtain information regarding a distance between the wearable device 1 and a subject positioned in front of the wearable device 1 by using the left and right cameras 150L and 150R. In the illustrated embodiment, the left and right cameras 150L and 150R may be partially visually recognized from the side in front of the wearable device 1 through the glass lens 130. However, according to another embodiment, the left and right cameras 150L and 150R may be partially accommodated in the rim 110.

Alternatively, a housing forming an external portion of the left and right cameras 150L and 150R may connect the rims 110 to each other to function as the bridge 120.

In the first camera 150 and the left and right cameras 150L and 150R illustrated in FIGS. 18 and 19, the reflection members 153, 153L, and 153R may be replaced with a machined surface of the glass lens 130, as illustrated in FIGS. 16A and 16B. For example, in FIG. 18, the reflection members 153, 153L, and 153R may be replaced with the reflection surface (for example, the reflection surface 131 of FIGS. 16A and 16B) as a part of the glass lens 130.

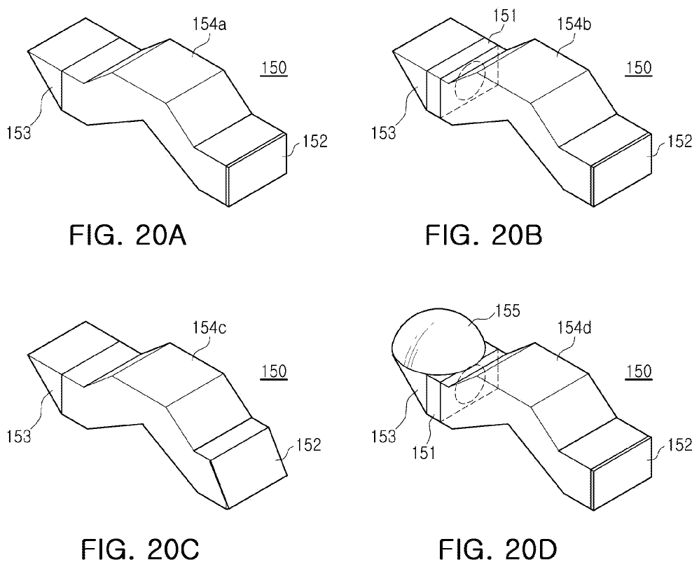

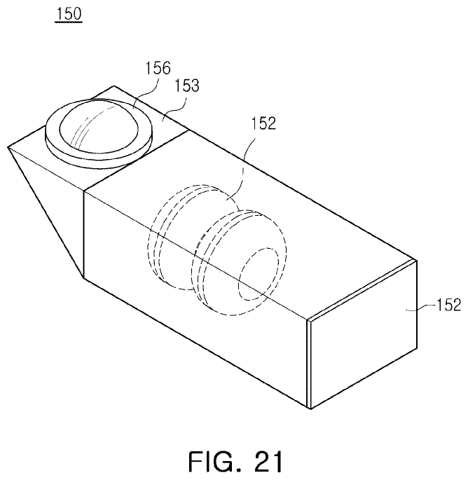

FIGS. 20A through 20D illustrate various forms of a light guide prism, according to an embodiment. FIG. 21 illustrates a lens 156 additionally disposed on the reflection member 153 of the first camera 150, according to an embodiment.

FIGS. 20A through 20D illustrate light guide prisms 154a, 154b, 154c, and 154d through which light passing through the reflection member 153 additionally passes before reaching the image sensor 152.

According to an embodiment, the light guide prism 154a, 154b, 154c, or 154d may be configured to reflect light incident to the light guide prism 154a, 154b, 154c, or 154d at least twice inside the light guide prism 154a, 154b, 154c, or 154d. According to an embodiment, the light guide prism 154a, 154b, 154c, or 154d may have two or more reflection surfaces. Light reflected from the reflection member 153 may be sequentially reflected from the reflection surfaces in the light guide prism 154a, 154b, 154c, or 154d and then reach the image sensor 152. According to an embodiment, the light guide prism 154a, 154b, 154c, or 154d may lengthen a path of the light. Therefore, the degree of freedom in designing disposition of the image sensor 152 may be further increased. For example, a distance between the reflection member 153 and the image sensor 152 may be freely increased by using the light guide prism 154a, 154b, 154c, or 154d.

According to an embodiment, the image sensor 152 may be disposed so as to form various angles with respect to the side in front of the wearable device 1 by using the light guide prism 154a, 154b, 154c, or 154d. For example, in the embodiments of FIGS. 20A, 20B, and 20D, the image sensor 152 is disposed at an angle of about 45° with respect to the reflection surface of the reflection member 153, and is oriented toward the lateral side of the wearable device 1. On the other hand, referring to the embodiment of FIG. 20C, the image sensor 152 may be disposed so as to be oblique with respect to both the lateral side of the wearable device 1 and the side in front of the wearable device 1. For example, the image sensor 152 may be oriented at an angle of about 45° (or 135°) with respect to the side in front of the wearable device 1.

Referring to the embodiment of FIG. 20B, an additional lens 151 may be provided between the light guide prism 154a, 154b, 154c, or 154d and the reflection member 153. In the illustrated embodiment, the additional lens 151 is schematically illustrated. Two or more lenses may be disposed between the reflection member 153 and the light guide prism 154a, 154b, 154c, or 154d.

Referring to the embodiment of FIG. 20D, a separate wide-angle lens 155 may be coupled to the reflection member 153. As the wide-angle lens 155 is provided in front of the reflection member 153, an angle of view of the camera may be increased.

Meanwhile, the embodiments illustrated in FIGS. 20A through 20D are only examples, and the form of the light guide prism 154a, 154b, 154c, or 154d and the forms of the lenses 151 and 155 may vary according to other embodiments.

Referring to FIG. 21, the separate lens 156 may be coupled to the reflection member 153 according to an embodiment. Since the separate lens 156 is provided in front of the reflection member 153, the angle of view of the camera may be increased.

The light guide prism 154a, 154b, 154c, or 154d or the lens 155 or 156 described with reference to FIGS. 20A through 21 may be similarly applied to the second camera 160 of FIG. 13.

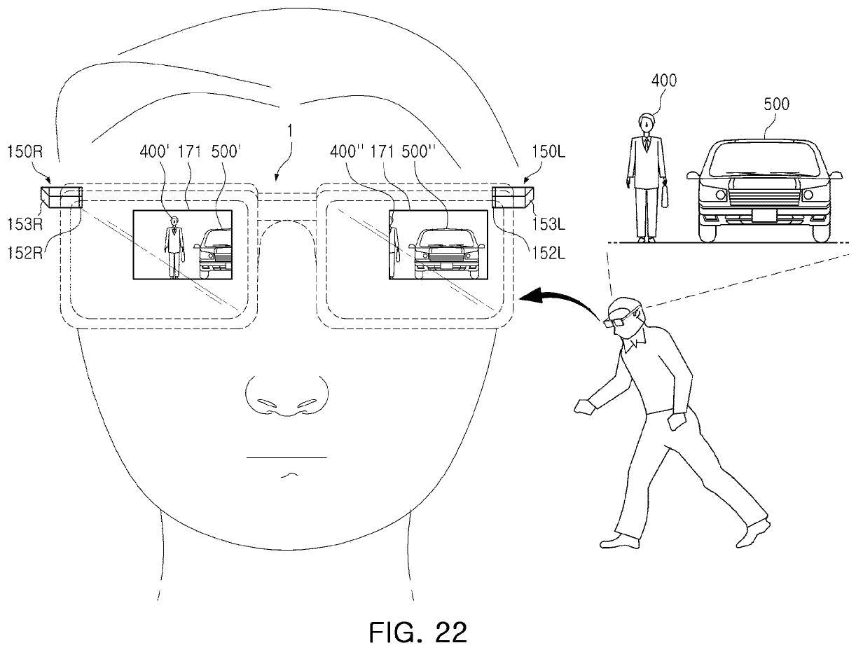

FIG. 22 illustrates a state in which the wearable device 1 displays a subject positioned behind the wearer, according to an embodiment.

Referring to FIG. 22, the wearable device 1 may include the left and right cameras 150L and 150R that may capture an image of an area behind the wearer on the left side and the right side, respectively. The left camera 150L may include the left reflection member 153L, at least one left lens 151L, and the left image sensor 152L, and the right camera 150R may include the right reflection member 153R, at least one right lens 151R, and the right image sensor 152R. The left or right image sensor 152L or 152R may be disposed so as to be oriented toward the lateral side (that is, the left side or the right side) of the wearable device 1, and the left or right reflection member 153L or 153R may be configured to reflect light incident from behind the wearer toward the left or right image sensor 152L or 152R.

According to an embodiment, the wearable device 1 may display, to the wearer, images of subjects 400 and 500 positioned behind the wearer, the image being captured by the left and right cameras 150L and 150R. For example, the wearable device 1 may include a screen 171 provided in the glass lens 130 and a projector that outputs an image on the screen 171, and a rear view of the wearer may be displayed on the screen 171. As another example, a transparent display may be provided in the lens of the wearable device 1 and the rear view may be directly output on the transparent display.

According to an embodiment, in a case in which the wearer walks on a street, the wearable device 1 may inform the wearer of an object positioned behind the wearer. Referring to FIG. 22, the left camera 150L captures images of a vehicle 500 and a pedestrian 400 positioned behind the wearer, and an image 400″ including an image 500″ of the vehicle and an image of a part or whole of the pedestrian may be displayed on the left side screen 171. According to an embodiment, the right camera 150R captures images of the vehicle 500 and the pedestrian 400 positioned behind the wearer, and an image 400′ including an image 500′ of the vehicle and an image of a part or whole of the pedestrian may be displayed on the right side screen 171.

According to an embodiment, the wearable device 1 may inform the wearer of a risk of approach of an object from behind by using the left and right cameras 150L and 150R. For example, the wearable device 1 may display a rearview image to inform the user of the risk when the vehicle 500 approaches the wearer from behind the wearer. The wearable device 1 may analyze an image obtained by each of the left and right cameras 150L and 150R to check a distance between the vehicle 500 and the wearer in real time, and in a case in which it is determined that the wearer may be in danger due to the vehicle 500, the wearable device 1 may display a warning alarm to the user based on the determined result.

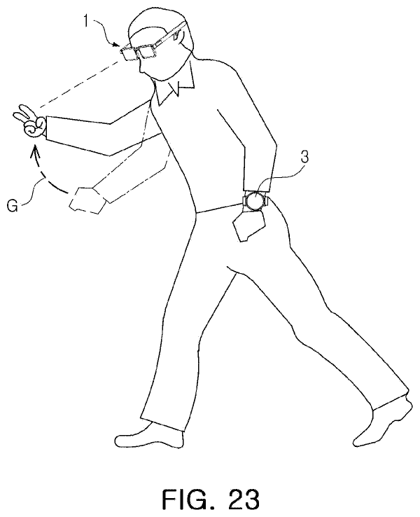

FIG. 23 illustrates gesture recognition using the wearable device 1, according to an embodiment.

According to an embodiment, the wearable device 1 may execute a function of recognizing a gesture of the wearer through the first camera 150 and perform an operation based on the recognized gesture. The wearable device 1 may execute a function of recording a gesture G of the hand of the wearer performing an operation based on the gesture G. For example, when the wearer listens to the music through the wearable device 1, the wearable device 1 may recognize a gesture in which the hand of the user moves upward or downward through the first camera 15-, and turn down or up the volume of the music in response to the gesture.

According to an embodiment, the wearable device 1 may recognize a still image in addition to a moving object (for example, the hand of the wearer) through the camera. For example, the wearable device 1 may execute a function of recognizing a designated shape and performing an operation based on the recognized shape. For example, the wearable device 1 may recognize the shape of the finger of the wearer by using the first camera 150, and execute a function corresponding to the recognized shape. As another example, in a case in which the wearer watches a QR code, the wearable device 1 may capture an image of the QR code by using the first camera 150, and execute a function corresponding to the QR code.

According to another embodiment, the wearable device 1 may receive an input signal from another wearable device worn by the wearer. For example, in a case in which the wearer wears a smartwatch, the wearer may use a button or a touch screen of the smartwatch to control the function of the wearable device 1.

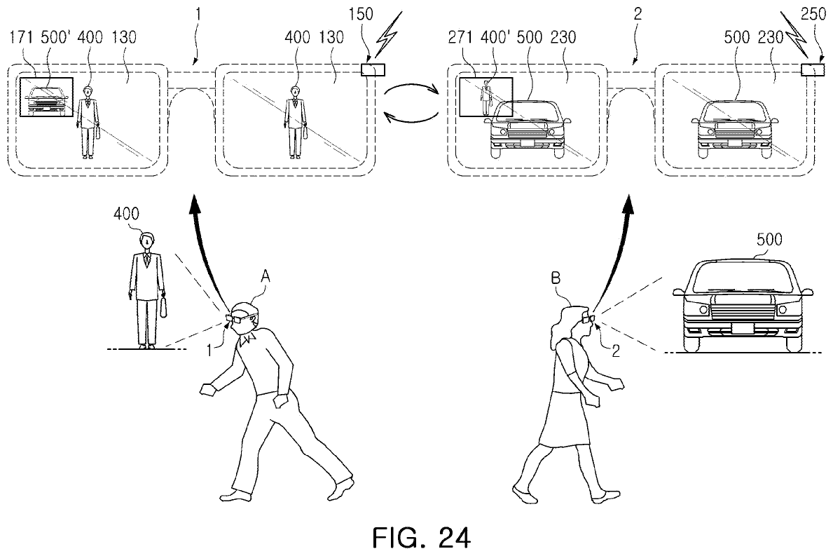

FIG. 24 illustrates a state in which users located in different places share fields of view with each other, according to an embodiment.

According to an embodiment, the wearers of the wearable devices 1 may share field-of-view information. According to an embodiment, in a case in which a first user A wearing a first wearable device 1 is looking at a pedestrian 400 positioned in front of the first user A, the first wearable device 1 may capture an image of the pedestrian 400 by using the camera and transmit the image to a second wearable device 2 including a glass lens 230, a first camera 250, and a screen 271.

For example, the first wearable device 1 may stream the captured image in real time through a communication circuitry. The second wearable device 2 may receive the image streamed by the first wearable device 1 and display a pedestrian image 400′ on the screen 271 of the second wearable device 2.

The second wearable device 2 may also capture an image of a vehicle 500 positioned in front of the second wearable device 2 and transmit corresponding image information to the first wearable device 1. The first wearable device 1 may display a vehicle image 500′ received from the second wearable device 2 on the screen 171. Therefore, the first user A and a second user B may share the fields of view with each other.

As another example, in a case in which the first user A is watching a baseball game, and the second user B is watching a soccer game, the first user A may watch the soccer game that the second user B is watching, through the wearable device 1 while watching the baseball game, and the second user B may also watch the baseball game that the first user A is watching, through the wearable device 2 while watching the soccer game.

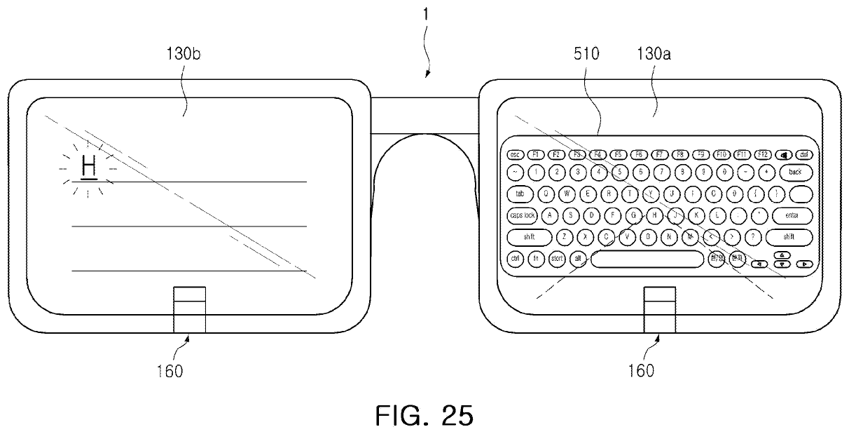

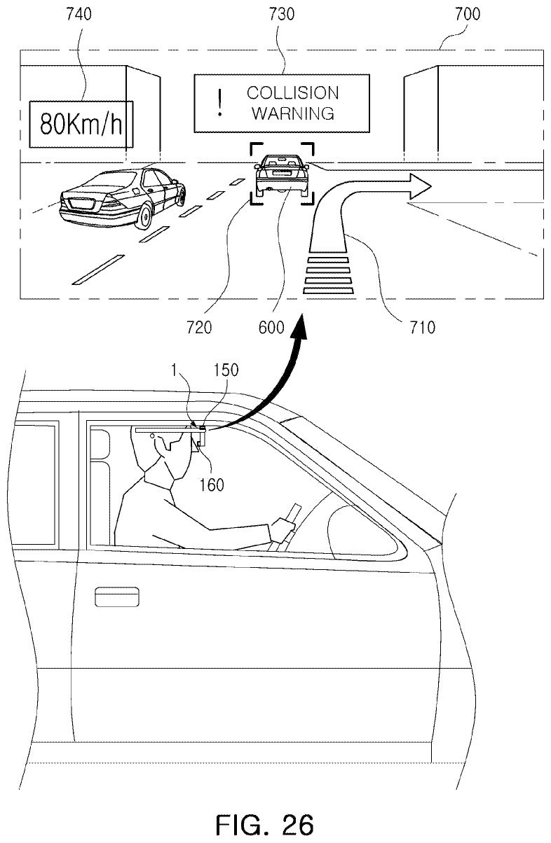

FIG. 25 illustrates a keyboard input using a gaze of the wearer, according to an embodiment.

According to an embodiment, the wearer may interact with the wearable device 1 only by using a gaze. According to an embodiment, the wearable device 1 may include the second camera 160 tracking the eye of the wearer, and the camera may measure a direction in which the eye of the wearer is directed.

The wearable device 1 may output a virtual keyboard 510 on a glass lens 130a (or a screen provided in the glass lens 130a) on one side, and the wearable device 1 may recognize a key of the virtual keyboard 510 to which the gaze of the wearer is directed by using the second camera 160. The wearable device 1 may detect a direction in which the gaze of the wearer is directed, determine a key corresponding to the direction in which the gaze is directed, and execute a function corresponding to the key. For example, the wearable device 1 inputs an “H” key based on a determination that the user is watching the “H” key. In a case in which the “H” key is input, the wearable device 1 may display the input of the “H” key on a glass lens 130b on the left side (or a screen provided in the glass lens 130b on the left side).

According to an embodiment, the wearable device 1 may recognize a blink of the wearer as a kind of instruction. The wearable device 1 may determine whether or not the eye of the wearer blinks, how many times the eye of the wearer blinks, or how fast the eye of the wearer blinks by using the second camera 160. For example, in a case in which the gaze of the wearer is fixed to a specific key and the eye of the wearer quickly blinks twice, the wearable device 1 may recognize that the specific key is clicked, and in a case in which the eye of the wearer does not blink, the wearable device 1 may recognize that no input is made.

FIG. 26 illustrates a driver wearing the wearable device 1 and a field of view of the driver, according to an embodiment.

According to an embodiment, the wearable device 1 may assist in driving. For example, the wearable device 1 may display a visual object 710 for guiding a route to a destination and vehicle state information 740 (for example, a remaining fuel amount, a state of charge of the battery, a speed, or an acceleration).

According to an embodiment, the wearable device 1 may display the visual guide 710 in addition to a front field of view actually viewed by the driver. For example, the wearable device 1 may superimpose the visual guide 710 on a route that the vehicle needs to follow to reach a destination. As another example, in a case in which a destination is within the field of the view of the driver, a visual object may be superimposed on the destination to help the driver be able to intuitively understand where the destination is located.

According to an embodiment, in a case in which the driver wears the wearable device 1, the wearable device 1 may measure a distance between the vehicle of the driver and a vehicle 600 located in front of the vehicle of the driver. The wearable device 1 may include two cameras (for example, two first cameras 150 provided at both sides of the wearable device 1) oriented toward the side in front of the wearable device 1, and a distance between the wearable device 1 and the preceding vehicle 600 may be measured by using the two camera. According to an embodiment, the wearable device 1 may provide various types of information to the driver based on information regarding a distance between the vehicle of the driver and another vehicle. For example, in a case in which a distance from the preceding vehicle rapidly decreases, the wearable device 1 may display a warning 730 that informs of a collision risk.

According to an embodiment, the wearable device 1 may measure a degree of alertness of the driver by using the second camera 160 and may issue a warning to the driver based on the measurement result. According to an embodiment, the wearable device 1 may monitor an interval or pattern of blinking of the eye of the driver through the second camera 160, and may determine whether or not the driver dozes off while driving based on the monitoring result. The wearable device 1 may issue a warning to the driver by using various means in a case in which it is determined that the driver dozes off while driving. For example, a feedback may be made for the driver by a warning sound output from the audio output device provided in the wearable device 1 or a vibration generated using the haptic module 188 (see FIG. 2).

According to an embodiment, in a case in which the driver does not keep his/her eyes forward, the wearable device 1 may issue a warning to make the driver keep his/her eyes forward. For example, the wearable device 1 may issue a warning to the driver based on a proportion of a time for which the driver keeps his/her eyes forward in a designated time interval.

According to an embodiment, the wearable device 1 may detect a posture of the face of the wearer. The wearable device 1 may detect movement of the head of the wearer through a head tracking camera (for example, the first camera 150 of FIG. 1). When the wearer moves his/her head, an angle of a subject obtained by the first camera 150 may be changed accordingly, and the wearable device 1 may detect the movement of the head of the wearer by using the obtained angle of the subject. For example, the wearable device 1 may detect a motion that the head of the user is turned left and right, a motion in which the user nods his/her head, and the like. According to another embodiment, the wearable device 1 may detect how the head of the wearer is moved by using a motion sensor such as an acceleration sensor or a gyro sensor.

According to an embodiment, the wearable device 1 may detect a motion of the head of the user and execute a function corresponding to the motion. For example, in a situation where the wearable device 1 asks the wearer for agreement on any item, when the user nods his/her head, it may be determined that the user agrees on the item, and when the user turns his/her head left and right, it may be determined that the user does not agree on the item. As another example, the wearable device 1 may operate a display menu according to a motion of the head, or may adjust a display position according to an angle of the head.

According to an embodiment, the wearable device 1 may measure a depth of an object positioned in front of the wearable device 1 by using two cameras. Based on the same principle that two eyes of a human are spaced apart from each other and may determine a distance to a subject, the wearable device 1 may obtain information regarding the depth of the subject by using two cameras spaced apart from each other.

According to an embodiment, one of two head tracking cameras (for example, the first camera 150 of FIG. 1) may be equipped with an RGB sensor, and the other one of the two head tracking cameras may be equipped with a monochrome sensor. In this case, the wearable device 1 may combine images obtained by two cameras, thereby improving image quality.

As set forth above, according to embodiments disclosed herein, various devices may be easily provided in a small space of a wearable device. For example, a battery or a camera provided in a wearable device according to the disclosure herein may contribute to improving the usability or appearance of the wearable device.

The input device 183, the sensor module 184, communication module 185, the processor 181, the main processor 181a, the auxiliary processor 181b, the memory 182, the power management unit 186, the display device 170, the audio module 187, the haptic module 188, the interface 189, the charging device 194, the processors, and the memories in FIGS. 1 to 26 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1 to 26 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wearable device, comprising:
a lens;
a frame including a rim surrounding the lens and a temple extending from the rim;
a reflection member altering a path of light incident from a side in front of the lens toward the lens;
an image sensor collecting light reflected from the reflection member; and
at least one camera lens disposed on a path of the light collected by the image sensor.

2. The wearable device of claim 1, wherein the reflection member is at least partially disposed inside the rim, and the image sensor is embedded in the frame.

3. The wearable device of claim 1, further comprising at least one electronic component electrically connected to the image sensor and embedded in the temple.

4. The wearable device of claim 3, wherein the temple is foldably coupled to the rim, the image sensor is electrically connected to the at least one electronic component, and the at least one electronic component is embedded in the temple through a flexible board.

5. The wearable device of claim 1, wherein the reflection member is a part of the lens.

6. The wearable device of claim 5, wherein the lens includes a reflection surface configured to alter a path of light toward the image sensor.

7. The wearable device of claim 6, wherein the glass lens further includes a recess at least partially defined by the reflection surface.

8. The wearable device of claim 1, wherein the reflection member and the image sensor are embedded in the rim.

9. The wearable device of claim 1, wherein the rim comprises two rims, and the frame further includes a bridge connecting of the two rims, and
wherein any one or any combination of any two or more of the reflection member, the lens, and the image sensor is embedded in the bridge.

10. The wearable device of claim 1, further comprising a light guide prism,
wherein the light guide prism is configured to reflect light incident to the light guide prism at least twice inside the light guide prism.

11. The wearable device of claim 1, further comprising a wide-angle lens disposed on an object side of the reflection member.

12. The wearable device of claim 1, further comprising:
electronic components; and
solid-state batteries configured to supply power to the electronic components.

13. The wearable device of claim 12, wherein each of the solid-state batteries includes:
a cathode;
an anode;
a body including a solid electrolyte layer disposed between the cathode and the anode; and
a first external electrode and a second external electrode, the first external electrode being disposed on one surface of the body and connected to the cathode, and the second external electrode being disposed on another surface of the body opposite to the one surface of the body and connected to the anode.

14. The wearable device of claim 12, further comprising battery cells each including at least one of the solid-state batteries,
wherein the battery cells are configured to supply power to the electronic components, respectively.

15. The wearable device of claim 14, further comprising a power manager electrically connected to the battery cells,
wherein the power manager is configured to selectively discharge a battery cell among the battery cells that is allocated to an activated electronic component among the electronic components.

16. The wearable device of claim 14, further comprising a power manager electrically connected to the battery cells,
wherein the power manager is configured to preferentially charge a battery cell, among the battery cells, that has a low state of charge over a battery cell, among the battery cells, that has a high state of charge.

17. The wearable device of claim 12, further comprising:
a power manager electrically connected to the solid-state batteries;
a main processor; and
a lithium ion battery,
wherein the power manager is configured to determine whether to discharge the lithium ion battery based on whether the main processor is activated.

18. A wearable device, comprising:
a lens;
a frame surrounding the lens;
a temple extending from the frame;
electronic components;
battery cells configured to supply power to the electronic components, respectively, each of the battery cells including at least one solid-state battery; and
a power manager configured to selectively discharge a battery cell among the battery cells that is allocated to an activated electronic component among the electronic components.

19. The wearable device of claim 18, wherein the electronic components, the battery cells, and the power manager are disposed in the temple.

20. The wearable device of claim 18, further comprising a camera disposed in the frame,
wherein a battery cell, among the battery cells, is configured to supply power to the camera.

21. The wearable device of claim 18, further comprising a main battery,
wherein the power manager is further configured to selectively discharge the main battery to charge a battery cell among the battery cells.

22. The wearable device of claim 18, wherein the power manager is further configured to preferentially charge a battery cell, among the battery cells, that has a low state of charge over a battery cell, among the battery cells, that has a high state of charge.

23. The wearable device of claim 18, further comprising:
a main processor; and
a main battery,
wherein the power manager is further configured to determine whether to discharge the main battery based on whether the main processor is activated.
